(19) United States
(12) Patent Application Publication
(10) Pub. No.: US 2025/0153190 A1
(43) Pub. Date: May 15, 2025

(54) METHODS AND SYSTEMS FOR SORTING PARTICLES IN FLUIDS

(71) Applicant: Oregon Health & Science University, Portland, OR (US)

(72) Inventors: Yu-Jui Chiu, Portland, OR (US); Ajay Sapre, Portland, OR (US); Jose Luis Montoya Mira, Portland, OR (US); Kyle Thomas Gustafson, Portland, OR (US)

(73) Assignee: Oregon Health & Science University, Portland, OR (US)

(21) Appl. No.: 18/834,945

(22) PCT Filed: Feb. 1, 2023
(86) PCT No.: PCT/US2023/061793

§ 371 Date: Jul. 31, 2024

Related U.S. Application Data
(60) Provisional application No. 63/306,017, filed on Feb. 2, 2022.

(51) Int. Cl. B03C 5/00; B03C 5/02; G01N 27/447; G01N 27/453

(52) U.S. Cl. CPC B03C 5/005; B03C 5/026; G01N 27/44791; G01N 27/453

(57) ABSTRACT

Described herein are systems and methods for sorting particles in fluids. Systems may comprise a microfluidic chamber, at least one array of electrodes arranged on the substrate, and a controller. The microfluidic chamber is configured to allow fluid to flow therethrough. The microfluidic chamber includes a substrate. The at least one array of electrodes is arranged on the substrate. The at least one array of electrodes is configured to apply dielectrophoretic (DEP) forces to the fluid flowing through the microfluidic chamber. A respective electrode of the at least one array of electrodes is configured to have a V-shape. The controller is configured to control the at least one array of electrodes.

### CROSS-REFERENCE TO RELATED APPLICATION

This is the U.S. National Phase of International Application No. PCT/US2023/061793, filed on Feb. 1, 2023, which application claims priority to and the benefit of the earlier filing of U.S. Provisional Application No. 63/306,017, filed on Feb. 2, 2022, which is incorporated by reference herein in its entirety.

### FIELD OF THE DISCLOSURE

This disclosure relates to systems and methods for improving effectiveness and efficiency in liquid biopsy in the context of tumor-derived biomarkers detection, and more specifically relates to methods and systems for sorting particles in fluids.

### BACKGROUND OF ASPECTS OF THE DISCLOSURE

Cancer is a major worldwide public health burden and the second leading cause of death in the United States (Wang et al., Lancet, 388(10053): 1459-1544, 2016, doi: 10.1016/S0140-6736(16) 31012-1). Advances in medical technologies led to significant progress in both treatment and diagnosis, yet clinicians rely on invasive and often risky biopsies for cancer detection. To address these limitations, the field of liquid biopsy has rapidly emerged as a non-invasive method to obtain tumor-derived biomarkers for diagnosis, staging, treatment, and prognosis (Wang et al., Front Med, 11(4): 522-527, 2017, doi: 10.1007/s11684-017-0526-7; Perakis et al., BMC Med, 15(1): 1-12, 2017, doi: 10.1186/s12916-017-0840-6).

Technologies that facilitate analyses of circulating biomarkers from blood for cancer detection are powerful and essential tools for improving disease treatment and patient outcomes. A plethora of circulating biomarkers derived directly from the primary tumor has been identified including circulating neoplastic cells such as circulating tumor cells (CTCs). However, translating CTCs to clinical use is a challenge due to CTCs' rarity. Current methods are restricted to lab-based approaches, which are low-throughput, time consuming, and rely on biased antibody panels. For example, in epithelial-derived tumors, CTCs are phenotypically defined as large cells (30 μm on average) lacking expression of the pan-leukocyte marker, CD45, and expressing cytokeratin (CK), epithelial cell adhesion molecule (EpCAM), or E-cadherin (ECAD) (Zhou et al., Microsystems Nanoeng, 5(1): 1-12, 2019, doi: 10.1038/s41378-019-0045-6; Kulemann et al., Sci Rep, 7(1): 1-11, 2017, doi: 10.1038/s41598-017-04601-z). CTC enrichment and isolation technologies exist, including the FDA-approved CellSearch® technology, to enumerate and phenotype CTCs to guide clinical prognosis (Wang et al., Semin Oncol, 43(4): 464-475, 2016, doi: 10.1053/j.seminoncol.2016.06.004). With estimates of one CTC per 10⁶-10⁸ leukocytes found in peripheral blood of pancreatic ductal adenocarcinoma (PDAC) patients, the extremely low level of these rare biomarkers pose a challenge, and thus improved approaches to capturing these rare cells are needed (Martini et al., Cancers, 11(11), 2019, doi: 10.3390/cancers11111659; Ankeny et al., Br J Cancer, 114(12): 1367-1375, 2016, doi: 10.1038/bjc.2016.121). Many groups have focused on using microfluidic sorting, density-based devices, size exclusion filtration, or marker specific isolation methods (Bankó et al., J Hematol Oncol, 12(1): 1-20, 2019, doi: 10.1186/s13045-019-0735-4; Ribeiro-Samy et al., Sci Rep, 9(1): 1-12, 2019, doi: 10.1038/s41598-019-44401-1; Xu et al., PLOS One, 10(9): e0138032, 2015, doi: 10.1371/journal.pone.0138032). These technologies rely on either a single physical property (size, density) or on specific protein expression (EpCAM, ECAD, CK) to differentiate CTCs from peripheral blood mononuclear cells (PBMCs). However, the rarity of CTCs has greatly limited its application in providing multi-omics information that encompasses tumor heterogeneity and has not translated well into widespread clinical use.

In the past 5 years, other promising types of unconventional circulating neoplastic cells have been described such as tumor hybrid cells (THC) and circulating hybrid cells (CHCs) (Aguirre et al., Oncoimmunology, 9(1), 2020, doi: 10.1080/2162402X.2020.1773204; Gast et al., Sci Adv, 4(9): 7828-7840, 2018, doi: 10.1126/sciadv.aat7828; WO2020056162; US20170106101). CHCs are described as having hybrid phenotypes of a neoplastic cell and a leukocyte with dual expression of CD45 and tumor markers such as EpCAM or CK (Ribeiro-Samy et al., Sci Rep, 9(1): 1-12, 2019, doi: 10.1038/s41598-019-44401-1; Gast et al., Sci Adv, 4(9): 7828-7840, 2018, doi: 10.1126/sciadv.aat7828; Dietz et al., bioRxiv, 2021.03.11.434896, 2021, doi: 10.1101/2021.03.11.434896). In PDAC patients, CHCs have shown better prognostic value than CTCs as their enumeration correlated with stage and survival (Cheng et al., Theranostics, 10(24): 11026-11048, 2020, doi: 10.7150/thno.44053). While CHCs are more abundant, their physical and phenotypic similarity to PBMCs makes their isolation and analysis a challenge (Ankeny et al., Br J Cancer, 114(12): 1367-1375, 2016, doi: 10.1038/bjc.2016.121; Manjunath et al., Int J Mol Sci, 21(5): 1872, 2020, doi: 10.3390/ijms21051872; Yan et al., Sci Rep, 7(1): 1-12, 2017, doi: 10.1038/srep43464; Lucci et al., Lancet Oncol, 13(7): 688-695, 2012, doi: 10.1016/S1470-2045(12) 70209-7; Resel Folkersma et al., Urology, 80(6): 1328-1332, 2012, doi: 10.1016/j.urology.2012.09.001; Adams et al., Proc Natl Acad Sci USA., 111(9): 3514-3519, 2014, doi: 10.1073/pnas.1320198111). Additional information about CTSs can be found in patent publications WO2020056162 and US20170106101.

Thus, improved approaches to capture rare circulating biomarkers for cancer detection are needed.

### SUMMARY OF THE DISCLOSURE

To address the above challenges, a microfluidic device utilizing the intrinsic dielectrophoretic (DEP) properties of cells to enable their label-free enrichment was developed, in a fashion compatible with both phenotypic and genotypic downstream analyses. When cells are exposed to this electric field, differential polarization is created between the cells and the surrounding media translating into a resultant force (Rahman et al., Sensors 17:449, 2017; doi: 10.3390/s17030449; Jones & Washizu, J Electrostat, 37(1-2): 121-134, 1996, doi: 10.1016/0304-3886(96) 00006-X). This resultant force can either be positive DEP where cells travel up the electric field (E-field) gradient, or negative DEP where cells travel down the gradient (Khoshmanesh et al., Biosens and Bioelectron, 26(5): 1800-1814, 2011, doi: 10.1016/j.bios.2010.09.022). The overall magnitude of the DEP force is dictated by the E-field gradient and the particle/cell geometry. Instead, the directionality of the force is determined by relative permittivity between the cell and the surrounding media and is specifically explained by the Clausius-Mossotti factor (Gascoyne et al., IEEE Tran. Ind Appl, 33(3): 670-678, 1997, doi: 10.1109/28.585856).

DEP as a cell differentiation approach can be grouped into two main categories, batch mode or continuous mode processing. Batch mode processing relies on a unique frequency cut-off where a cell's DEP response changes between positive and negative, for each discrete cell type. Defined frequencies can then be used to separate two cell groups to positive or negative DEP regimes followed by flushing out the negative DEP partition. This approach provides enhanced specificity for discrete cell types expressing narrow dielectrophoretic variance, however it's utility is impeded by low throughput and narrow search space (Gonzalez & Remcho, J Chromatogr A, 1079(1-2): 59-68, 2005, doi: 10.1016/j.chroma.2005.03.070; Becker et al., Proc Natl Acad Sci USA, 92(3): 860-864, 1995, doi: 10.1073/pnas.92.3.860; Yang, Anal Chem, 71(5): 911-918, 1999, doi: 10.1021/ac981250p; Gascoyne et al., Electrophoresis, 30(8): 1388-1398, 2009, doi: 10.1002/elps.200800373; Esmaeilsabzali et al., Biotechnol Adv, 31(7): 1063-1084 Nov. 15, 2013, doi: 10.1016/j.biotechadv.2013.08.016; Di Trapani et al., Cytom Part A, 93(12): 1260-1266, 2018, doi: 10.1002/cyto.a.23687). In contrast, continuous mode processing uses a secondary force (flow, acoustic or others) to incrementally bias cell trajectory over a period of time (Hu et al., Proc Natl Acad Sci USA, 102(44): 15757-15761, 2005, doi: 10.1073/pnas.0507719102; Smith et al., Sci Rep, 7(1): 1-15, 2017, doi: 10.1038/srep41872; Balasubramanian et al., PLOS One, 12(4): e0175414, 2017, doi: 10.1371/journal.pone.0175414). The combination of continuous flow and DEP can result in multiple cell sorting outcomes in high cell density environments translating into a versatile high-throughput methodology for mixed cell populations with variant dielectrophoretic responses. The majority of strategies currently employed for rare cell enrichment are reliant on clearly defined physical properties and minimal phenotypic variation of the target cell population. However, this approach fails for heterogeneous cell populations with high phenotypic and DEP variance making it unlikely for a single condition to be successful. To address these limitations, a continuous mode DEP based microfluidic device to allow for enrichment of highly heterogenous rare cell populations like CHCs was designed and optimized. The workflow was validated using charged beads, optimized on cell lines and PBMCs, then tested on specimens from cancer patients. In this disclosure, PBMCs from a small amount of blood (2 mL) were sorted in a high-density environment where non-target immune cells were depleted from the sample enriching for neoplastic cells in a label-free manner. As a proof of concept, enriched CHCs were subjected to phenotypic and genotypic downstream analysis demonstrating clinically relevant KRAS mutation status in PDAC tumors.

Techniques discussed herein provide improvements to methods and systems for sorting particles in fluids.

An aspect of this disclosure provides a system for sorting particles in fluids. The system comprises a microfluidic chamber, at least one array of electrodes arranged on the substrate, and a controller. The microfluidic chamber is configured to allow fluid to flow therethrough. The microfluidic chamber includes a substrate. The at least one array of electrodes is arranged on the substrate. The at least one array of electrodes is configured to apply dielectrophoretic (DEP) forces to the fluid flowing through the microfluidic chamber. A respective electrode of the at least one array of electrodes is configured to have a V-shape. The controller is configured to control the at least one array of electrodes.

In some instances, the microfluidic chamber further comprises a first inlet configured to introduce a sample into the microfluidic chamber, and a plurality of outlets configured to collect a plurality of types of particles in the sample.

In some instances, the system further comprises a buffer exchange module configured to mix a buffer and the sample. The buffer exchange module is in fluid communication with the first inlet.

In some instances, the sample includes cells, synthetic micro-particles, nano-particles, viruses, bacteria, nucleic acids, and/or proteins.

In some instances, the sample includes prokaryotic cells and/or eukaryotic cells.

In some instances, the sample includes red blood cells (RBCs), lymphocytes, CHCs, fusion cells, and/or disease related cells.

In some instances, a ratio of a distance to a width of the microfluidic chamber is between 1:10 and 2:1, where the distance is measured from the first inlet to an apex of a first array of electrodes of the at least one array of electrodes.

In some instances, the microfluidic chamber further comprises a second inlet and a third inlet configured to introduce sheath flows into the microfluidic chamber.

In some instances, a ratio of a first width of the first inlet to a second width of the second inlet to a third width of the third inlet is between 0.5:1:1 and 2:1:1.

In some instances, the ratio of the first width of the first inlet to the second width of the second inlet to the third width of the third inlet is 1:1.5:1.5.

In some instances, the plurality of outlets includes a first outlet, a second outlet, and a third outlet. A ratio of a fourth width of the first outlet to a fifth width of the second outlet to a sixth width of the third outlet is between 0.2:1:1 and 8:1:1

In some instances, the ratio of the fourth width of the first outlet to the fifth width of the second outlet to the sixth width of the third outlet is 1.73:1:1.

In some instances, the buffer has a relatively low conductivity between 20 mS/m and 800 mS/m.

In some instances, the buffer includes at least one of dextrose, sucrose, water, bovine serum albumin, fetal bovine serum, sugars, proteins, amino acids, salts, and/or lipids.

In some instances, a length of the microfluidic chamber is between 10 mm and 50 mm.

In some instances, a width of the microfluidic chamber is between 0.5 mm and 5 mm.

In some instances, a height of the microfluidic chamber is between 20 μm and 100 μm.

In some instances, a first array of electrodes of the at least one array of electrodes is configured to operate at a frequency between 1 Mhz and 20 Mhz and a voltage between 5 V and 20 V.

In some instances, a second array of electrodes of the at least one array of electrodes is configured to operate at a frequency between 4 Mhz and 9 Mhz and a voltage between 5 V and 20 V.

In some instances, a third array of electrodes of the at least one array of electrodes is configured to operate at a frequency between 9 Mhz and 14 Mhz and a voltage between 5 V and 20 V.

In some instances, a respective array of electrodes of the at least one array of electrodes includes 60 pairs of interdigitated electrodes.

In some instances, a total length of the at least one array of electrodes is between 65% and 95% of a length of the microfluidic chamber.

In some instances, a length of a respective array of electrodes of the at least one array of electrodes is between 5 mm and 50 mm.

In some instances, a first gap is arranged between a first array of electrodes and a second array of electrodes of the at least one array of electrodes, and a first width of the first gap is between 250 μm to 1 mm.

In some instances, a second gap is arranged between a second array of electrodes and a third array of electrodes of the at least one array of electrodes, and a second width of the second gap is between 250 μm to 1 mm.

In some instances, a width of the respective electrode is between 10 μm and 50 μm.

In some instances, a spacing is arranged between two adjacent electrodes of a respective array of electrodes of the at least one array of electrodes, and a ratio of a width of the respective electrode to a width of the spacing is between 1:0.5 and 1:1.5.

In some instances, an edge portion of the respective electrode is covered with insulating material.

In some instances, a width of the edge portion of the respective electrode covered with the insulating material is between 5% and 15% of a width of the microfluidic chamber.

In some instances, a distance between an endpoint of the respective electrode and a sidewall of the microfluidic chamber is 50-300 μm.

In some instances, the respective electrode includes a first segment and a second segment connected to the first segment at an apex. The first segment and the second segment form the V-shape. An angle between the first segment and the second segment is between 30 degrees and 60 degrees.

In some instances, the substrate and the at least one array of electrodes constitute a chip, and no overall coating is provided on the chip.

Another aspect of this disclosure provides a method for sorting particles in fluids. The method comprises the following operations. A fluid sample is introduced into a microfluidic chamber via a first inlet of the microfluidic chamber of a microfluidic system. The microfluidic chamber is configured to allow the fluid sample to flow therethrough. At least one array of electrodes is controlled to apply DEP forces to the fluid sample flowing through the microfluidic chamber. The at least one array of electrodes is arranged on a substrate in the microfluidic chamber, and a respective electrode of the plurality of the arrays of electrodes is configured to have a V-shape. A plurality of types of particles in the fluid sample is collected at a plurality of outlets of the microfluidic chamber.

In some instances, the operation of controlling the at least one array of electrodes comprises the following operations. A first array of electrodes of the at least one array of electrodes is controlled to operate based on a first set of parameters. A second array of electrodes of the at least one array of electrodes is controlled to operate based on a second set of parameters.

In some instances, the first set of parameters includes a first frequency between 1 Mhz and 20 Mhz and a first voltage between 5 V and 20 V.

In some instances, the second set of parameters includes a second frequency between 4 Mhz and 9 Mhz and a second voltage between 5 V and 20 V.

In some instances, the operation of controlling the at least one array of electrodes further comprises the following operation. A third array of electrodes of the at least one array of electrodes is controlled to operate based on a third set of parameters.

In some instances, the third set of parameters includes a third frequency between 9 Mhz and 14 Mhz and a third voltage between 5 V and 20 V.

In some instances, the method further comprises the following operation. Sheath flows are introduced into the microfluidic chamber via a second inlet and a third inlet of the microfluidic chamber.

In some instances, the fluid sample includes cells, synthetic micro-particles, nano-particles, viruses, bacteria, nucleic acids, and/or proteins.

In some instances, the fluid sample includes prokaryotic cells and/or eukaryotic cells.

In some instances, the fluid sample includes a first type of particle, a second type of particle, and/or a third type of particle.

In some instances, the first type of particle includes RBCs, the second type of particle includes lymphocytes, and the third type of particle includes circulating CHCs.

Yet another aspect of this disclosure provides a computer-readable storage medium storing computer-readable instructions executable by one or more processors, that when executed by the one or more processors, cause the one or more processors to perform the following operations. A fluid sample is introduced into a microfluidic chamber via a first inlet of the microfluidic chamber of a microfluidic system. The microfluidic chamber is configured to allow the fluid sample to flow therethrough. At least one array of electrodes is controlled to apply DEP forces to the fluid sample flowing through the microfluidic chamber. The at least one array of electrodes is arranged on a substrate in the microfluidic chamber, and a respective electrode of the plurality of the arrays of electrodes is configured to have a V-shape. A plurality of types of particles in the fluid sample is collected at a plurality of outlets of the microfluidic chamber.

In some instances, the operation of controlling the at least one array of electrodes comprises the following operations. A first array of electrodes of the at least one array of electrodes is controlled to operate based on a first set of parameters. A second array of electrodes of the at least one array of electrodes is controlled to operate based on a second set of parameters.

In some instances, the first set of parameters includes a first frequency between 1 Mhz and 20 Mhz and a first voltage between 5 V and 20 V.

In some instances, the second set of parameters includes a second frequency between 4 Mhz and 9 Mhz and a second voltage between 5 V and 20 V.

In some instances, the operation of controlling the at least one array of electrodes further comprises the following operation. A third array of electrodes of the at least one array of electrodes is controlled to operate based on a third set of parameters.

In some instances, the third set of parameters includes a third frequency between 9 Mhz and 14 Mhz and a third voltage between 5 V and 20 V.

Techniques discussed here may sort/separate particles in fluids can be based on differential DEP response characterizations of the particles. Sorting/enrichment of a target type of particles can be achieved by depleting other types of particles in the sample. Further, techniques discussed here include depletion of undesired particles in the sample such as healthy peripheral blood mononuclear cells (PBMCs) to drive the sorting/enrichment of the target particles such as the CHC population. Effectiveness and efficiency in liquid biopsy in the context of tumor-derived biomarkers detection can be improved. The problem in conventional techniques where the cell isolation of rare cells is time and labor intensive and harsh on the sample can be addressed.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1A and FIG. 1B illustrate a top view of an exemplary microfluidic system for sorting particles in fluids according to implementations of this disclosure.

FIG. 1C illustrates an image of an example microfluidic system for sorting particles in fluids according to implementations of this disclosure.

FIG. 1D illustrates a partial side view of the example microfluidic system taken from A-A′ in FIG. 1A.

FIG. 1E illustrates a partial side view of the example microfluidic system taken from A-A′ in FIG. 1A, showing the movement of an example particle in the sample.

FIG. 1F illustrates a partial top view of the example microfluidic system showing the movement of an example particle in the sample.

FIG. 2 illustrates a top view of an example buffer exchange module according to implementations of this disclosure.

FIG. 3 illustrates a top view of another example microfluidic system according to implementations of this disclosure.

FIG. 4 illustrates a graph showing DEP responses of CHCs and lymphocytes according to implementations of this disclosure.

FIG. 5 illustrates an image showing the movement of lymphocytes.

FIG. 6A, FIG. 6B, and FIG. 6C illustrate flowcharts of an example process for sorting particles in fluids.

FIG. 7 illustrates an example computer architecture for a computer capable of executing program components for performing operations and/or processes as described throughout this disclosure.

FIG. 8 illustrates an example workflow for label-free enrichment of unconventional circulating neoplastic cells (such as CHCs).

FIG. 9 illustrates fluorescent images of the microfluidic chamber showing differential responses of different types of polystyrene beads with 10 μm (green) and 2 μm (blue) diameters.

FIG. 10 illustrates percent of beads collected from the center outlet at an optimal condition (5 MHZ), a sub-optimal condition (300 kHz), and with no applied DEP.

FIG. 11 illustrates PBMC subpopulation analysis as presented by depletion of CD3+, CD14+, CD19+, and CD45+ cells across frequencies, 13 MHz to 18 MHz at a constant 8 Vpp by flow cytometry.

FIG. 12 illustrates fluorescent images near the inlet (Part I), at the center between batches of electrodes (Part II), and close to the outlet (Part III) of the microfluidic channel revealed depletion of MCF7 (green) and less reactive B16Mφ (red) at 15 MHz and 8 V.

FIG. 13 illustrates percent depletion of B16Mφ, MCF7, and PBMCs from the center outlet across frequencies, 13 MHz to 19 MHz, at a constant 8 V by flow cytometry.

FIG. 14 illustrates equations for center enrichment and side loss used for FIG. 15A and FIG. 15B.

FIG. 15A illustrates center enrichment heatmap with voltage (V) in the y axis and frequency (MHz) in the x axes (n=1-5).

FIG. 15B illustrates percentage side loss heatmap with voltage (V) in the y axis and frequency (MHz) in the x axes (n=1-5).

FIG. 16 illustrates in situ immunofluorescence microscopy analysis of PBMCs before device processing, arrows indicate presence of CHCs (Hoescht+/CD45+/CK+).

FIG. 17A illustrates average diameter (μm) of CHCs and PBMCs from in situ immunofluorescence images.

FIG. 17B illustrates average clinical sample DNA extracted from cells collected from all outlets (n=4).

FIG. 18 illustrates percent KRAS^{mut} copies for each patient (n=4) from all outlets compared to average KRAS^{mut} copies for screen-negative controls (n=5) measured by ddPCR.

FIG. 19 illustrates cell viability over incubation time in various buffer conditions. DEP buffer shows high cells viability similar to standard cell culture media.

FIG. 20 illustrates depletion of PBMCs from healthy participants based on Flow cytometry analysis and depletion of PDAC patients PBMCs based on DNA quantification.

### DETAILED DESCRIPTION

Disclosed herein are implementations of systems, methods, apparatuses, and computer-readable media for sorting particles in fluids. In exemplary aspects, the fluids include a physiologic fluid, such as blood or a blood faction (such as plasma or serum), lymph, urine, saliva, synovial fluid, vitreous fluid, interstitial fluid, amniotic fluid, and so forth; or a synthetic physiologic fluid or supplement (such as, for instance, a blood substitute).

As will be understood by one of ordinary skill in the art, each embodiment disclosed herein can comprise, consist essentially of or consist of its particular stated element, step, ingredient or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients or components and to those that do not materially affect the embodiment.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it is individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents, printed publications, journal articles and other written text throughout this specification (referenced materials herein). Each of the referenced materials is individually incorporated herein by reference in their entirety for their referenced teaching.

It is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

Definitions and explanations used in the present disclosure are meant and intended to be controlling in any future construction unless clearly and unambiguously modified in the example(s) or when application of the meaning renders any construction meaningless or essentially meaningless. In cases where the construction of the term would render it meaningless or essentially meaningless, the definition should be taken from Webster's Dictionary, 3rd Edition or a dictionary known to those of ordinary skill in the art, such as the Oxford Dictionary of Biochemistry and Molecular Biology (Ed. Anthony Smith, Oxford University Press, Oxford, 2004).

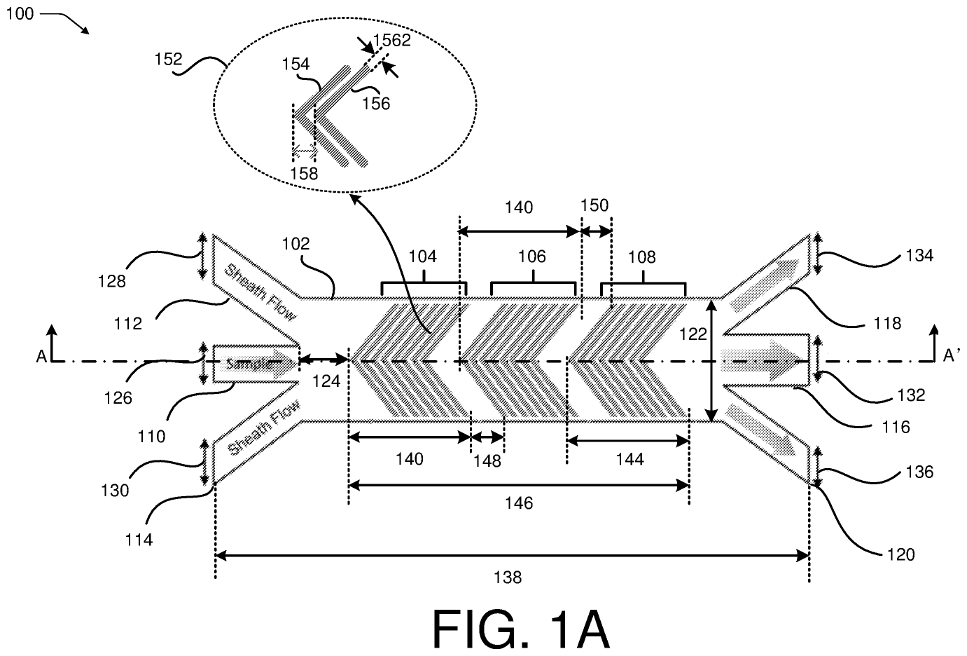

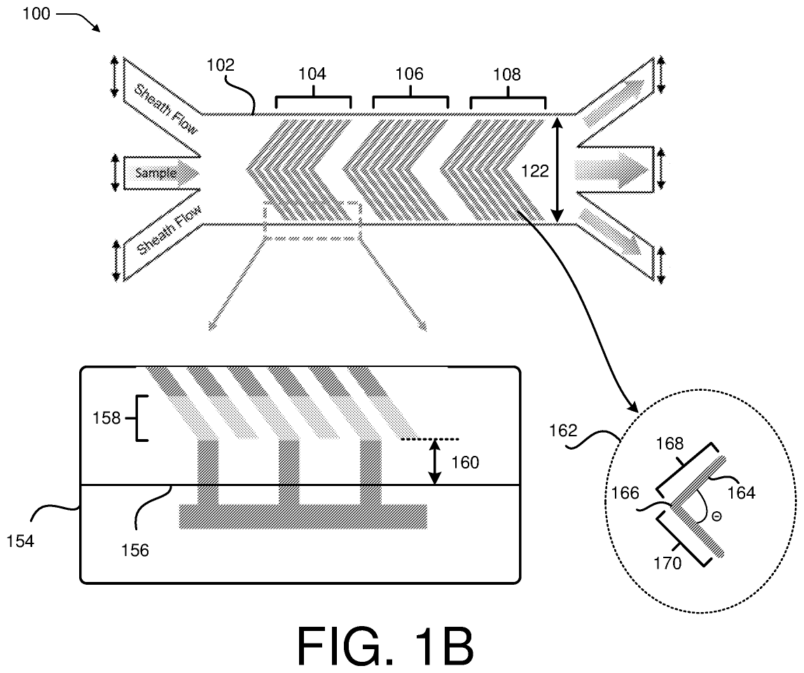

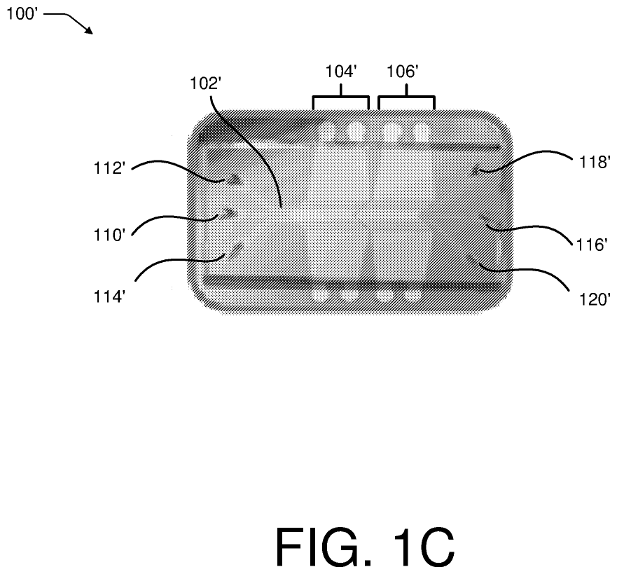

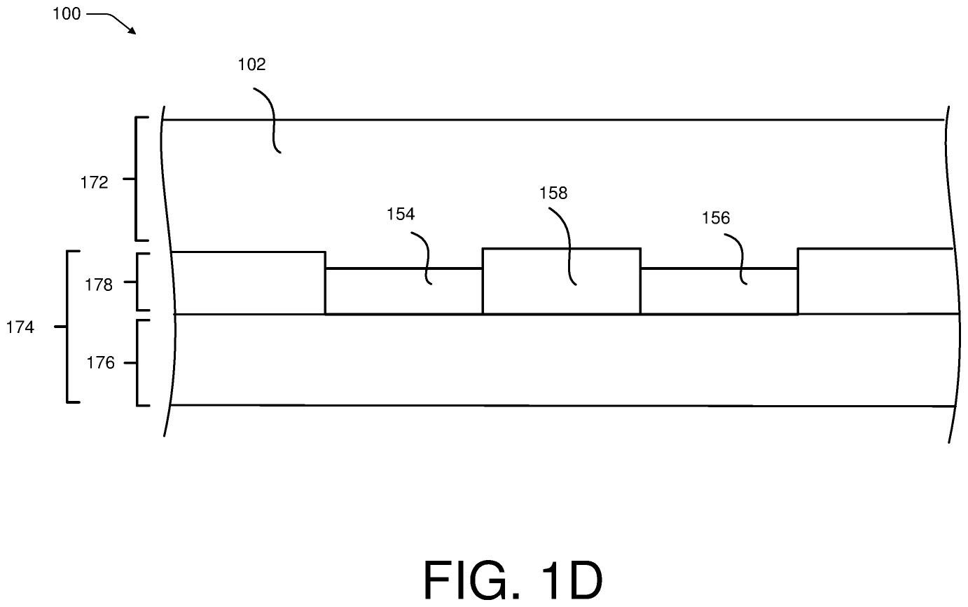

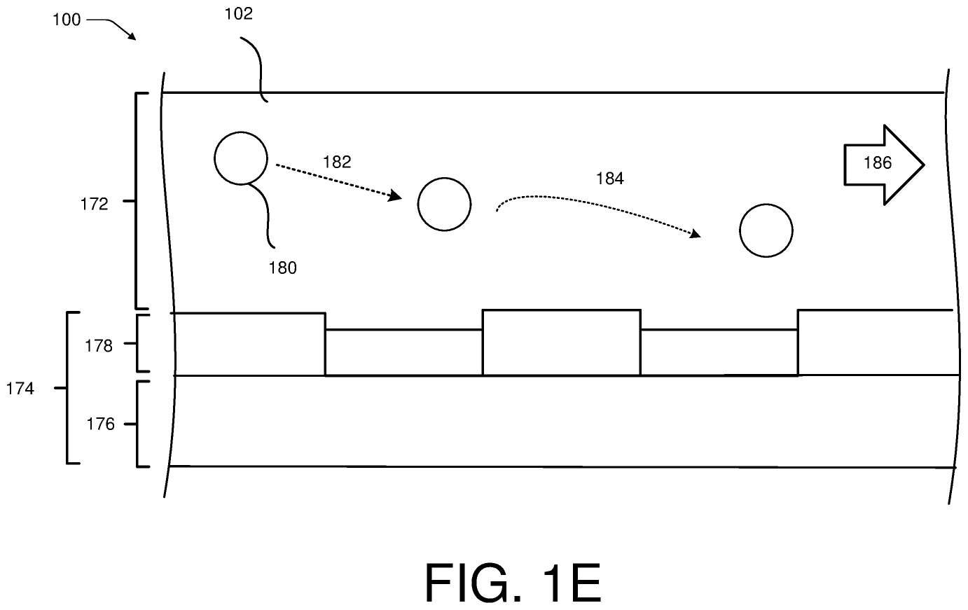

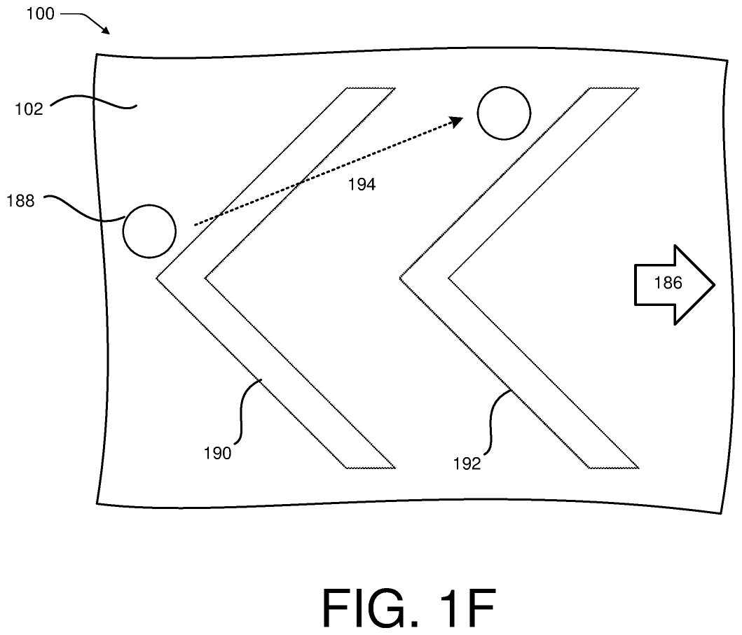

FIG. 1A and FIG. 1B illustrate a top view of an exemplary microfluidic system 100 for sorting particles in fluids according to implementations of this disclosure. The particles include cells, synthetic micro-particles, nano-particles, viruses, bacteria, nucleic acids, proteins, etc., and this disclosure is not limited thereto. Referring to FIG. 1A, the microfluidic system 100 includes a microfluidic chamber 102. The microfluidic chamber 102 is configured to allow fluid to flow therethrough. The microfluidic chamber 102 includes a substrate (not shown). The microfluidic system 100 further includes at least one array of electrodes (104, 106, and 108) arranged on the substrate.

In implementations, the at least one array of electrodes includes a first array of electrodes 104, a second array of electrodes 106, and a third array of electrodes 108. Though three arrays of electrodes are shown in FIG. 1A, there may be other numbers of arrays of electrodes, for example, two arrays of electrodes, four arrays of electrodes, and N arrays of electrodes, where N is a positive integer. This disclosure is not limited thereto. The at least one array of electrodes is configured to apply dielectrophoretic (DEP) forces to the fluid flowing through the microfluidic chamber 102. DEP refers to a force which can act upon particles in a non-uniform electric field. As a result of differing particle properties, DEP can sort/separate particles in static or flowing fluids.

The microfluidic system 100 further includes a controller (not shown) configured to control the at least one array of electrodes.

The microfluidic chamber 102 further includes at least one inlet (110, 112, and 114) and a plurality of outlets (116, 118, and 120). Though FIG. 1A shows three inlets (110, 112, and 114) and three outlets (116, 118, and 120), there may be other numbers of inlets and outlets, and this disclosure is not limited thereto.

In implementations, the at least one inlet includes a first inlet 110 configured to introduce a sample into the microfluidic chamber, a second inlet 112 and a third inlet 114 configured to introduce sheath flows into the microfluidic chamber 102. As an example, the first inlet 110 is a central inlet, while the second inlet 112 and the third inlet 114 are side inlets.

In implementations, the plurality of outlets includes a first outlet 116, a second outlet 118, and a third outlet 120. As an example, the first outlet is a central outlet 116, while the second outlet 118 and the third outlet 120 are side outlets. The plurality of outlets (116, 118, and 120) is configured to collect a plurality of types of particles in the sample. In implementations, the central outlet (first outlet) 116 is wider than the side outlets (the second outlet and the third outlet) 118 and 120, such that particles with relatively high DEP responsive characterization are allowed to be depleted from the fluid from the side outlets (the second outlet and the third outlet) 118 and 120. For example, the central outlet (the first outlet) 116 may have a width of 0.9 mm, and each of the side outlets 118 and 120 may have a width of 0.8 mm, where a total sheath to fluid ratio is 16:9. During operation, the flow of the fluid is pulled from all three outlets (116, 118, and 120) by two flow-driven syringe pumps, and this pump withdrawal setup provides enhanced flow stability compared to an active infusion from the inlet(s). The center-focused flow is adjusted to a flow rate of 2 μL/min for each of the sheath flow and 2.5 L/minute for the central outlet (the first outlet) 116.

In implementations, the microfluidic chamber 102 may have a width 122. As an example, the width 122 of the microfluidic chamber 102 is between 0.5 mm and 5 mm. The width 122 of the microfluidic chamber 102 may be other values, and this disclosure is not limited thereto.

In implementations, there is a distance 124 between the first inlet 110 to an apex of the first array 104 of electrodes. The ratio of the distance 124 to the width 144 of the microfluidic chamber 102 is between 1:10 and 2:1. As an example, the distance 122 is 1.3 mm. The ratio of the distance 124 to the width 144 of the microfluidic chamber 102 may be other values, and this disclosure is not limited thereto.

In implementations, the first inlet 110 has a first width 126, the second inlet 112 has a second width 128, and the third inlet 114 has a third width 130. In some instances, the ratio of the first width 126 to the second width 128 to the third width 130 is between 0.5:1:1 and 2:1:1. As an example, the ratio of the first width 126 to the second width 128 to the third width 130 is 1:1.5:1.5. For example, the first width 126 is 0.5 mm, and the second width 128 and the third width 130 are both 0.75 mm. The ratio of the first width 126 to the second width 128 to the third width 130 is other values, and this disclosure is not limited thereto.

In implementations, the first outlet 116 has a fourth width 132, the second outlet 118 has a fifth width 134, and the third outlet 120 has a sixth width 136. The ratio of the fourth width 132 to the fifth width 134 to the sixth width 136 is between 0.2:1:1 and 8:1:1. As an example, the ratio of the fourth width 132 to the fifth width 134 to the sixth width 136 is 9:5.5:5.5. For example, the fourth width 132 is 0.9 mm, and fifth width 134 and the sixth width 136 are both 0.55 mm. As another example, the ratio of the fourth width 132 to the fifth width 134 to the sixth width 136 is 1.73:1:1. The ratio of the fourth width 132 to the fifth width 134 to the sixth width 136 may be other values, and this disclosure is not limited thereto.

In implementations, the microfluidic chamber 102 has a length 138. The length 138 of the microfluidic chamber 102 is measured from the start point of the inlets to the endpoint of the outlets. For example, the length 138 of the microfluidic chamber 102 is 10-50 mm. As an example, the length 138 of the microfluidic chamber 102 is 21. mm. The length 138 of the microfluidic chamber 102 may be other values, and this disclosure is not limited thereto.

In implementations, the microfluidic chamber 102 has a height (not shown). The height of the microfluidic chamber 102 is between 20 μm and 100 μm. As an example, the height of the microfluidic chamber 102 is 26 μm. The height of the microfluidic chamber 102 may be other values, and this disclosure is not limited thereto.

In implementations, a length of a respective array of electrodes is between 5 mm and 50 mm. A length of a respective array of electrodes is measured from the apex of the first electrode of the array of electrodes to the endpoint of the last electrode of the array of electrodes. As an example, the length of a respective array of electrodes is 8.5 mm. The first array 104 of electrodes may have a first length 140. The second array 106 of electrodes may have a second length 142. The third array 108 may have a third length 144. The first length 140, the second length 142, and the third length 144 may be the same or different. Each of the first length 140, the second length 142, and the third length 144 may fall within the range of 5 mm to 50 mm. The first length 140, the second length 142, and the third length 144 may have other values, and this disclosure is not limited thereto.

In implementations, a total length 146 of the at least one array of electrodes is between 17 mm and 152 mm. The total length 146 of the at least one array of electrodes is measured from the apex of the first electrode of the first array 104 of electrodes to the endpoint of the last electrode of the last array 108 of electrodes. The total length 146 of the at least one array of electrodes is between 65% and 95% of the length of the microfluidic chamber 138. As an example, the total length 146 of the at least one array of electrodes is 80% of the length of the microfluidic chamber 138. As an example, a respective array of electrodes includes 60 pairs of interdigitated electrodes, that is, 120 total electrodes. The total length 146 of the at least one array of electrodes may have other values, and this disclosure is not limited thereto.

In implementations, a first gap 148 is arranged between the first array of electrodes 104 and the second array 106 of electrodes. The width of the first gap 148 is between 250 μm and 1 mm. The width of the first gap 148 is measured from the endpoint of the last electrode of the first array of electrodes 104 and the endpoint of the first electrode of the second array 106 of electrodes. As an example, the width of the first gap 148 is 500 μm.

In implementations, a second gap 150 is arranged between the second array of electrodes 106 and the third array 108 of electrodes. The width of the second gap 150 is between 250 μm to 1 mm. The width of the second gap 150 is measured from the endpoint of the last electrode of the second array of electrodes 106 and the endpoint of the first electrode of the third array 108 of electrodes. As an example, the width of the second gap 150 is 500 μm.

Bubble 152 shows an expanded view of two adjacent electrodes 154 and 156 within the same array of electrodes. In implementations, a respective electrode may have a width 1562. The width 1562 of a respective electrode is between 10 μm and 50 μm. As an example, the width 1562 of the respective electrode is 25 μm. As another example, the width 1562 of the respective electrode is 35 μm. As yet another example, the width 1562 of the respective electrode is 50 μm. All of the electrodes within the same array may have the same width. In implementations, a spacing 158 is arranged between two adjacent electrodes 154 and 156 in the same array. A ratio of the width 1562 of the respective electrode to a size of the spacing 158 is between 1:0.5 and 1:1.5. In some instances, the ratio of the width 1562 of the respective electrode to the size of the spacing 158 is 1:1. For example, the width 1562 of the respective electrode is 25 μm, and the size of the spacing is 25 μm. As another example, the width 1562 of the respective electrode is 35 μm, and the size of the spacing is 35 μm. In some instances, spacings between a series of adjacent electrodes may have different sizes. For example, the width 1562 of the respective electrode is 25 μm, and the size of the spacing is 20 μm and 80 μm. As another example, the width 1562 of the respective electrode is 50 μm, and the size of the spacing is 25 μm and 75 μm. The width 1562 of the respective electrode, the size of the spacing is configured approximately 2-3 times the size of PBMCs, to minimize cells being captured on the electrodes by DEP forces. In implementations, the width 1562 of the respective electrode, the size of the spacing, and the ratio therebetween may have other values, and this disclosure is not limited thereto.

In implementations, the first array 104 of electrodes, the second array 106 of electrodes, and the third array of electrodes 108 is configured to operate based on different sets of parameters to apply different DEP forces to the fluid flowing through the microfluidic chamber 102 so as to sort/separate different types of particles in the sample. For example, the first array 104 of electrodes is configured to apply DEP forces to sort/separate a first type of particle in the sample; the second array 106 of electrodes is configured to sort/separate a second type of particle in the sample; and the third array of electrodes 108 is configured to sort/separate a third type of particle.

In some instances, the first array 104 of electrodes is configured to operate at a frequency between 1 Mhz and 20 Mhz and a voltage between 5 V and 20 V. The second array 106 of electrodes is configured to operate at a frequency between 4 Mhz and 9 Mhz and a voltage between 5 V and 20 V. The third array of electrodes 108 is configured to operate at a frequency between 9 Mhz and 14 Mhz and a voltage between 5 V and 20 V.

In some instances, the sample includes cells, fusion cells, hybrid cells, synthetic micro-particles, nano-particles, viruses, bacteria, nucleic acids, and/or proteins. In some instances, the sample includes prokaryotic cells and/or eukaryotic cells. In some instances, the sample includes whole blood. In some instances, the sample includes PBMCs. In some instances, the sample includes enriched PBMCs. In some instances, the first type of particles includes red blood cells, the second type of particles includes lymphocytes, and the third type of particles includes cancer cells such as CHCs. In some instances, particles in the sample include eukaryotic cells, fusion cells, hybrid cells, synthetic micro-particles, nano-particles, viruses, bacteria (or other prokaryotic cells), nucleic acids, and proteins. This disclosure is not limited thereto.

The term “cell” as used herein refers to the basic structural and functional units normally found in a eukaryotic body, as well as to prokaryotic cells. The term “cell” in various embodiments may include nucleate cell and/or anucleate cells of eukaryotes, such as mature erythrocytes or platelets. In some embodiments, the cells are mammalian cells; for instance, in embodiments they are human cells. In further embodiments, they are cells from non-human animals, such as mice, rats, guinea pigs, dogs, hogs, monkeys, etc.

The term “normal cell” refers to a cell in a state or condition considered generally healthy or productive for its state of development, growth, activity, function, or maturity. Normal cells may also be viewed as those without an identifiable disease state or defect impairing their functions commensurate with their state of development, growth, activity, function, or maturity. It is recognized that a “normal cell” may be normal/healthy in only some aspects of its state of development, growth, activity, function, or maturity, while other aspects may be outside of a norm. For instance, a cell may be considered “normal” as to its state of development, while being abnormal with regard to another characteristic.

An “abnormal cell” is one which deviates from a normal state for any reason associated with a disease, trauma, or other deviation from normal development or activity. A “modified cell” refers to a cell having a genetic complement modified by human intervention, such as through genetic modification or manipulation.

A “diseased cell” or “disease related cell” or “diseased state cell” refers to a cell experiencing a pathologic, oncologic, or other disease challenge. Diseased cells for use in the models, designs, devices, and methods herein may be from any source, including disease cell lines or patient/donor samples.

Diseased cells that may be analyzed in the devices and methods described herein include leukemia [acute myeloid leukemia (AML), chronic myeloid leukemia (CML), atypical CML, chronic neutrophilic leukemia, acute lymphoblastic leukemia (ALL), etc.], multiple myeloma, smoldering myeloma, monoclonal gammopathy of undetermined significance, Non-Hodgkin lymphoma, Chronic lymphocytic leukemia (CLL), monoclonal B lymphocytosis, Hodgkin lymphoma, T-cell lymphoma, bone marrow failure syndromes, myelodysplastic syndrome (MDS), clonal hematopoiesis of indeterminate potential (CHIP), clonal cytopenias of undetermined significance (CCUS), aplastic anemia, and metastatic solid tumors that travel to the bone marrow (lung, breast, kidney, prostate, thyroid, etc.).

Diseased state cells can include MSCs, macrocytes, polychromatophilic reticulocytes, aggregate reticulocytes, punctate reticulocytes, target cells, spherocytes, ovalocytes/elliptocytes, stromatocytes, sickle cells, acanthocytes, schistocytes, helmet cells, dacrocytes/teardrop cells, echinocytes/Burr cells, Pappenheimer bodies, Cabot ring cells, punctate basophilia/basophilic stippling cells, Heinz-Endrich bodies, codocytes/leptocytes, megaloblastic cells, hypochromic red blood cells, microcytic red blood cells, macrocytic red blood cells, knizocytes, degmacytes, fragmented red blood cells, Thalassemia red blood cells, degmacytes (bite cell red blood cells), and Hemoglobin C Crystal red blood cells.

The diseased state cells can also include cells of bone marrow cancers, including mature cancer cells, cancer induced angiogenesis, including, but not limited to, multiple myeloma cells and multiple myeloma precursor cells (cells exhibiting monoclonal gammopathy of unknown significance and smoldering myeloma cells), leukemic stem cells, leukemic blast cells, and leukemic promyelocytes.

More generally, disease related cells may arise from other disease states, including infectious diseases, deficiency diseases (e.g., arising from malnutrition or nutritional deficiency, which is viewed generally as a deficiency, excess, or imbalance of energy, protein and other nutrients that adversely impacts tissue, development, and/or form of a subject), hereditary diseases (including both genetic diseases and non-genetic hereditary diseases), physiological diseases (including diabetes, glaucoma, hypertension, cardiovascular diseases, and so forth), and neuropsychiatric diseases and conditions (including depression and anxiety).

Thus, contemplated are disease related cells resulting from infection (by an infectious agent) of the subject from which the cells are derived. The term “infectious agent,” as used herein, refers to agents that cause an infection and/or a disease. Infectious agents include viruses, bacteria, fungi, and parasites, or a combination thereof. In some embodiments, the infectious agent is a virus. For instance, a viral infectious agent may be a coronavirus, a Corynebacterium, an ebolavirus, an orthomyxovirus, a hepatovirus, a Haemophilus bacterium, HIV, HPV, a morbillivirus, a Mycobacterium, a meningococcus bacterium, an orthorubulavirus, a norovirus, a Streptococcus, an enterovirus, an orthopneumovirus, a rotavirus, a rubivirus, a herpesvirus, a Clostridium bacterium, a Bordetella bacterium, or a flavivirus. Pathogens are also referred to as infectious agents.

The term “infectious disease,” as used herein, refers to diseases caused by infectious agents such as bacteria, viruses, parasites, or fungi. In some embodiments, the infectious disease is a viral infection. Examples of the infectious diseases include coronavirus-based infections (such as middle east respiratory syndrome (MERS), severe acute respiratory syndrome (SARS), and coronavirus diseases (e.g., COVID-19)); Corynebacterium-based infections (such as diphtheria); ebolavirus-based infections (such as Ebola); orthomyxoviridae virus-based infections (such as influenza A, B, or C); hepatovirus A, B, C, D, or E-based infections (such as hepatitis); Haemophilus-based infections (such as hib disease); human immunodeficiency virus (HIV)-based infections (such as acquired immunodeficiency syndrome (AIDS)); human papillomavirus (HPV)-based infections; Morbillivirus-based infections (such as measles); Mycobacterium-based infections (such as tuberculosis); Neisseria-based infections (such as meningitis); Orthorubulavirus-based infections (such as mumps); norovirus-based infections; Streptococcus-based infections; enterovirus-based infections (such as polio); Orthopneumovirus-based infections; rotavirus-based infections; Rubivirus-based infections (such as rubella); herpesvirus-based infections (such as herpes, chickenpox, and shingles); Clostridium-based infections (such as tetanus and botulism); Bordatella-based infections (such as pertussis); Flavivirus-based infections (such as Zika); and so on. Additional infectious diseases will be known to those of ordinary skill in the art (e.g., Pati et al., Front Immunol. 9:2224, 2018, and references cited therein).

As an example, purified PBMCs from whole blood is loaded into the microfluidic system 100 and acted upon. The first array 104 of electrodes can act on a first subpopulation of particle in the sample to remove the first subpopulation of particles from the center flow, enriching the targeted particles in the center flow. The second array 106 of electrodes can act on a second subpopulation of particle in the sample, separating the second subpopulation of particle, and further enriching the targeted particles in the center flow. Cancer related circulating cells such as CHCs may experience low DEP forces within the frequency ranges of 9 Mhz to 14 Mhz, and therefore can be sorted/enriched in the center flow and be collected at the center outlet (the first outlet) 116, but may also be found in other outlets (such as 118 and 120).

In implementations, the substrate and the at least one array of electrodes 104, 106, and 108 constitute a chip, and no overall coating is provided on the chip. Without the overall coating on the chip, processing time of the sample can be reduced because coating the chip can take up to 1 hour in spatial solutions. Moreover, not coating the chip allows the operator to clean/re-use the microfluidic system much more easily because there is no extra layer to remove from the chip. Further, without the overall coating on the chip, clogging can be decreased. If the chip has an overall coating, after the microfluidic system is used for a long time, the coating may start peeling off or aggregating which clogs the microfluidic system and damages the sample.

Referring to FIG. 1B, bubble 154 shows an expanded view of the edge configuration of the first array 104 of electrodes near the sidewall 156 of the microfluidic chamber 102.

In implementations, an edge portion 158 the first array 104 of electrodes is covered with insulating material. The insulating material includes silicon dioxide, silicone, or any suitable type of insulator. This disclosure is not limited thereto. A width 158 of the edge portion covered with the insulating material is between 5% and 15% of the width 122 of the microfluidic chamber 102. For example, a distance 160 between an endpoint of a respective electrode and the sidewall 156 of the microfluidic chamber 102 is 50-300 μm. The second array 106 of electrodes and the third array 108 of electrodes may have the same edge configuration as the first array 104 of electrodes.

The electrodes with covered edge portions may provide the following advantages. For example, the cell viability of the sample can be improved. When the edge portion of the electrode is exposed, the exposed edge portion becomes a maximum point for the DEP force and a low point for flow force due to the boundary effect. As a result, cells in the sample flowing through the microfluidic chamber may get trapped and die due to being prolonged contact with the electrodes. On the other hand, with the electrodes with covered edge portions, cells are driven by the flow force near the sidewall of the microfluidic chamber and cells may hop between electrodes without getting stuck. Such covered edge portions of electrodes avoid cells being trapped at the region where DEP forces are much stronger than the flow stress and ensure enough shear force to carry sorted cells along the direction of flow. Additionally, the durability of the microfluidic system 100 can be improved. Cell death, clumping, and aggregating may cause the microfluidic system 100 to stop working. By decreasing the cell death, the microfluidic system 100 the electrodes with covered edge portions may process the sample longer.

Bubble 162 shows an expanded view of a respective electrode 164. In implementations, the respective electrode 164 is configured to have a V-shape. The respective electrode 164 includes an apex 166, a first segment 168, and a second segment 170. The first segment 168 and the second segment 170 are connected at the apex 166. There is an angle θ between the first segment 168 and the second segment 170. The angle θ is between 30 degrees and 60 degrees. As an example, the angle θ is 45 degrees. As another example, the angle θ is 30 degrees. As yet another example, the angle θ is 60 degrees. In implementations, the angle θ may have other values, and this disclosure is not limited thereto.

As an example, PBMC resuspended in the buffer was used as the sample to be introduced into the microfluidic chamber 102 of the microfluidic system 100 via the first inlet 110. One of the at least one array of electrodes operated at a frequency of 5 MHZ-9 MHZ with a voltage of 5 V to 20 V while flow from all the three outlets 116, 118, and 120 are withdrawn. The original PBMC sample and the sorted sample collected from the outlets were transferred to individual poly-d-lysine treated glass slides. The original PBMC sample and the sorted sample were fixed followed by fluorescent stained with tumor related and PBMC related markers. The slides were imaged by the fluorescent microscope, and cells stained with different colors are numerically counted. The sample from the central outlet (the first outlet) 116 showed at least 16% tumor related cells (CHC, CTC, Camel cell, etc.) within all the collected cells. Such result was at least 3 times more compared to the original PBMC sample directly transferred to the poly-d-lysine treated glass slide.

As another example, healthy subject PBMCs spiked with a hybrid cell line was used. DEP differential responses on PBMCs and cancer cells are analyzed. Up to 96.5% depletion of PBMCs resulted in an 18.6-fold enrichment of cancer cells. In peripheral blood from pancreatic adenocarcinoma patients, the microfluidic system 100 enriched for disseminated neoplastic cells that were identified by their KRAS mutant status by droplet digital PCR from only 2 mL of whole blood with one hour of processing. The microfluidic system 100 facilitated label-free enrichment of KRAS mutated cells in 75% of the clinical samples analyzed, establishing this approach as a promising way to non-invasively analyze tumor cells from patients.

With the microfluidic system 100 that applies DEP field flow fractionation, particles in fluids can be sorted/separated based on differential DEP response characterizations of the particles. Sorting/enrichment of a target type of particles can be achieved by depleting other types of particles in the sample. Effectiveness and efficiency in liquid biopsy in the context of tumor-derived biomarkers detection can be improved. The problem in conventional techniques where the cell isolation of rare cells is time and labor intensive and harsh on the sample can be addressed.

FIG. 1C shows an image of an example microfluidic system 100′ for sorting particles in fluids according to implementations of this disclosure.

Referring to FIG. 1C, the microfluidic system 100′ includes a microfluidic chamber 102′. The microfluidic chamber 102′ is configured to allow fluid to flow therethrough. The microfluidic chamber 102′ includes a substrate (not shown). For additional details of the microfluidic chamber 102′, reference may be made to descriptions of the microfluidic chamber 102, which are not repeated here. The microfluidic system 100′ further includes at least one array (104′ and 106′) of electrodes arranged on the substrate.

In implementations, the at least one array of electrodes includes a first array 104′ of electrodes and a second array 106′ of electrodes. The at least one array (104′ and 106′) of electrodes is configured to apply dielectrophoretic (DEP) forces to the fluid flowing through the microfluidic chamber 102′. For additional details of the at least one array 104′ and 106′ of electrodes, reference may be made to descriptions of the at least one array 104 and 106 of electrodes, which are not repeated here.

In implementations, the microfluidic system 100′ further includes a controller (not shown) configured to control the at least one array (104′ and 106′) of electrodes.

In implementations, the microfluidic system 100′ further includes at least one inlet (110′, 112′, and 114′) and a plurality of outlets (116′, 118′, and 120′).

In implementations, the at least one inlet includes a first inlet 110′ configured to introduce a sample into the microfluidic chamber 102′, a second inlet 112′ and a third inlet 114′ configured to introduce sheath flows into the microfluidic chamber 102′. As an example, the first inlet 110′ is a central inlet, and the second inlet 112′ and the third inlet 114′ are side inlets. For additional details of the inlets 110′, 112′, and 114′, reference may be made to descriptions of the inlets 110, 112, and 114, which are not repeated here.

In implementations, the plurality of outlets includes a first outlet 116′, a second outlet 118′, and a third outlet 120′. As an example, the first outlet is a central outlet 116′, and the second outlet 118′ and the third outlet 120′ are side outlets. The plurality of outlets (116′, 118′, and 120′) is configured to collect a plurality of types of particles in the sample. For additional details of the outlets 116′, 118′, and 120′, reference may be made to descriptions of the outlets 116, 118, and 120, which are not repeated here.

In implementations, a respective electrode is configured to have a V-shape.

In implementations, the first array 104′ of electrodes and the second array 106′ of electrodes are configured to operate based on different sets of parameters to apply different DEP forces to the fluid flowing through the microfluidic chamber 102′ so as to sort/separate different types of particles in the sample. For example, the first array 104′ of electrodes is configured to apply DEP forces to sort/separate a first type of particle in the sample; the second array 106′ of electrodes is configured to sort/separate a second type of particle in the sample.

In some instances, the first array 104′ of electrodes is configured to operate at a frequency between 1 Mhz and 20 Mhz and a voltage between 5 V and 20 V, and the second array 106′ of electrodes is configured to operate at a frequency between 4 Mhz and 9 Mhz and a voltage between 5 V and 20 V.

With the microfluidic system 100′ that applies DEP field flow fractionation, particles in fluids can be sorted/separated based on differential DEP response characterizations of the particles. Sorting/enrichment of a target type of particles can be achieved by depleting other types of particles in the sample. Effectiveness and efficiency in liquid biopsy in the context of tumor-derived biomarkers detection can be improved. The problem in conventional techniques where the cell isolation of rare cells is time and labor intensive and harsh on the sample can be addressed.

FIG. 1D illustrates a partial side view of the example microfluidic system 100 taken from A-A′ in FIG. 1A.

Referring to FIG. 1D, the microfluidic system 100 includes a top layer 172 (which includes the microfluidic chamber 102) and a bottom layer 174. The bottom layer includes the substrate 176 and an electrode layer 178. The bottom layer further includes a partial passivation layer (not shown) that covered the edge portion of the electrode layer near the sidewall of the microfluidic chamber 102.

In implementations, the electrode layer 178 includes at least one array of electrodes, and each array of electrodes includes interdigitated electrodes and spacings. For the purposes of illustration, FIG. 1D shows two adjacent electrodes 154 and 156, and the spacing 158 therebetween.

In implementations, to form the microfluidic chamber 106, the top layer 172 is bonded on top of the bottom layer 174, e.g., by using surface modification and heat treatment and/or adding adhesion material in between. For example, the top layer 172 and the bottom layer 174 are bonded to each other through plasma treatment and heat curing. Additional details of the microfluidic system 100 are given throughout this disclosure and are not repeated herein.

The top layer 172 (i.e., the microfluidic chamber) is formed with a polydimethylsiloxane (PDMS) or any other suitable material, and this disclosure is not limited thereto. The substrate 176 is made of P-type silicon or any other suitable material, and this disclosure is not limited thereto.

In implementations, the electrodes (such as 154 and 156) is configured to sort/separate particles in the fluid by electrical and physical properties and therefore differentiate fluid constituents. The electrodes (such as 154 and 156) are configured as a conductive component for DEP actuation.

In implementations, the electrodes (such as 154 and 156) are made of conducting material. For example, the electrodes (such as 154 and 156) are made of platinum and gold. For example, the electrodes (such as 154 and 156) are made of indium tin oxide, metallic wire, and/or spin-coated or printed carbon. In implementations, the electrodes (such as 154 and 156) are made using physical vapor deposition, magnetron sputtering deposition, electron-beam, physical vapor deposition, or any other suitable processing, and this disclosure is not limited thereto.

In implementations, a respective electrode (such as 154 and 156) may have a thickness of 50 nm to 5 μm, for example, 90 nm.

In implementations, spacing 158 is made of insulating material. For example, the spacing 158 is made of silicon dioxide (SiO₂), silicon nitride (SiN₂), and/or a combination thereof. In implementations, the spacing 158 may have a thickness of 510 nm. Additional details of the electrodes and the spacing are given throughout this disclosure and are not repeated herein.

FIG. 1E illustrates a partial side view of the example microfluidic system 100 taken from A-A′ in FIG. 1A, showing the movement of an example particle 180 in the sample.

Referring to FIG. 1E, an example particle 180 in the sample may move along a route denoted by arrows 182 and 184 in the microfluidic chamber 102 along the flow direction 186. The route denoted by arrows 182 and 184 is for the purpose of illustration and this disclosure is not limited thereto.

FIG. 1F illustrates a partial top view of the example microfluidic system 100 showing the movement of an example particle 188 in the sample.

Referring to FIG. 1F, an electrode 190 may locate near the inlets of the microfluidic system 100, and another electrode 192 may locate near the outlets of the microfluidic system 100. The example particle 188 may move along the route denoted by the arrow 194. The route denoted by arrow 194 is for the purpose of illustration and this disclosure is not limited thereto. In implementations, any undesired particles are be urged by the DEP force from a central part of the microfluidic chamber 102 to a side of the microfluidic chamber 102.

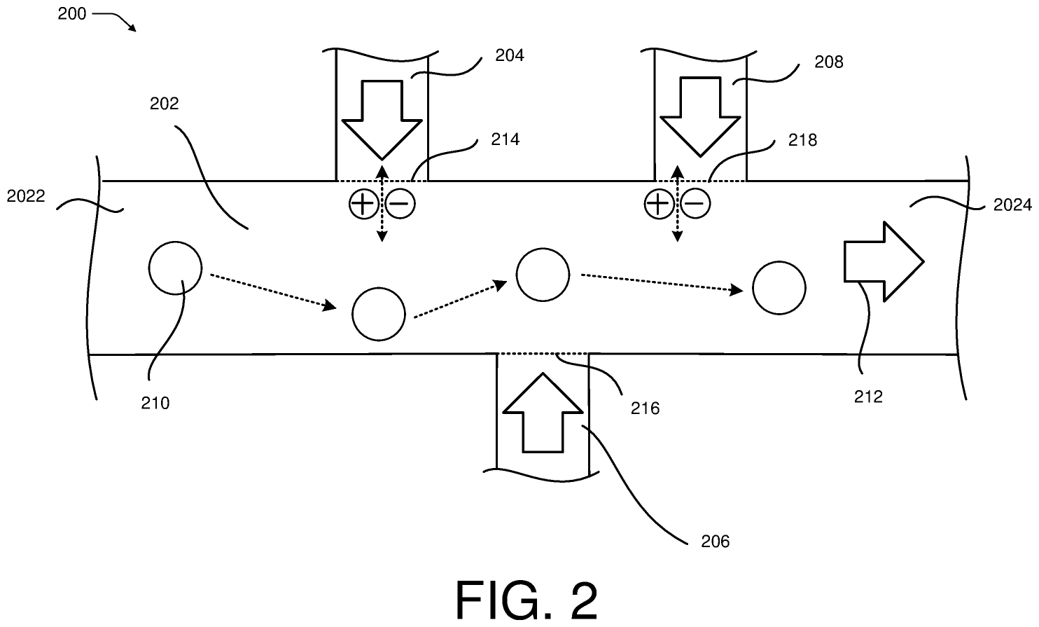

FIG. 2 illustrates a top view of an example buffer exchange module 200 according to implementations of this disclosure. In implementations, the buffer exchange module 200 is configured to mix the buffer and the sample and in fluid communication with one of the inlets (such as the first inlet 110) of the microfluidic chamber 102.

In implementations, the microfluidic system 100 further includes the buffer exchange module 200. The buffer exchange module 200 includes a channel 202 and a plurality of buffer inlets 204, 206, and 208 in fluid communication with the channel 202. Though FIG. 2 shows three buffer inlets, there may be other numbers of buffer inlets, and this disclosure is not limited thereto. The plurality of buffer inlets 204, 206, and 208 is configured to introduce DEP buffer to the channel 202. The DEP buffer may have a relatively low conductivity, for example, between 20 mS/m and 800 mS/m. As an example, the conductivity of the DEP buffer is 145 mS/m. As an example, the DEP buffer is iso-osmotic. In implementations, the DEP buffer includes dextrose, sucrose, water, bovine serum albumin, fetal bovine serum, sugars, proteins, amino acids, salts, and/or lipids. The DEP buffer may include other ingredients, and this disclosure is not limited thereto.

In implementations, the channel 202 includes an inlet 2022 and an outlet 2024. The inlet 2022 is configured to introduce the sample into the channel 202. The outlet 2024 is in fluid communication with the inlet 110 of the microfluidic chamber 102 as described above. That is, an outflow of the channel 202 may flow into the microfluidic chamber 102.

In implementations, particles 210 in the sample may flow through the channel 202 where the DEP buffer is introduced from the plurality of buffer inlets 204, 206, and 208. The particles 210 are physically confined at the direction perpendicular to the flow direction 212 by the on-chip physical barrier. In the channel 202, the flow rate of the sample is between 20 μL/min and 200 μL/min. As an example, the flow rate of the sample is 40 μL/min for optimizing the sample speed. The flow rate of the DEP buffer is between 40 μL/mins and 400 μL/mins. For example, the flow rate of the DEP buffer is 80 μL/min for optimizing sample lateral shifting. In implementations, the flow rate of the DEP buffer and the flow rate of the sample may either be modulated or kept constant throughout the operation of the processing.

In implementations, a filter is arranged between the respective buffer inlet and the channel 202. For example, a first filter 214 is arranged between the first buffer inlet 204 and the channel 202. A second filter 216 is arranged between the second buffer inlet 206 and the channel 202. A third filter 218 is arranged between the third buffer inlet 208 and the channel 202. Ion exchange may occur between the DEP buffer and the sample across the first filter 214, the second filter 216, and the third filter 218. Though FIG. 2 shows three filters, there may be other numbers of filters, and this disclosure is not limited thereto.

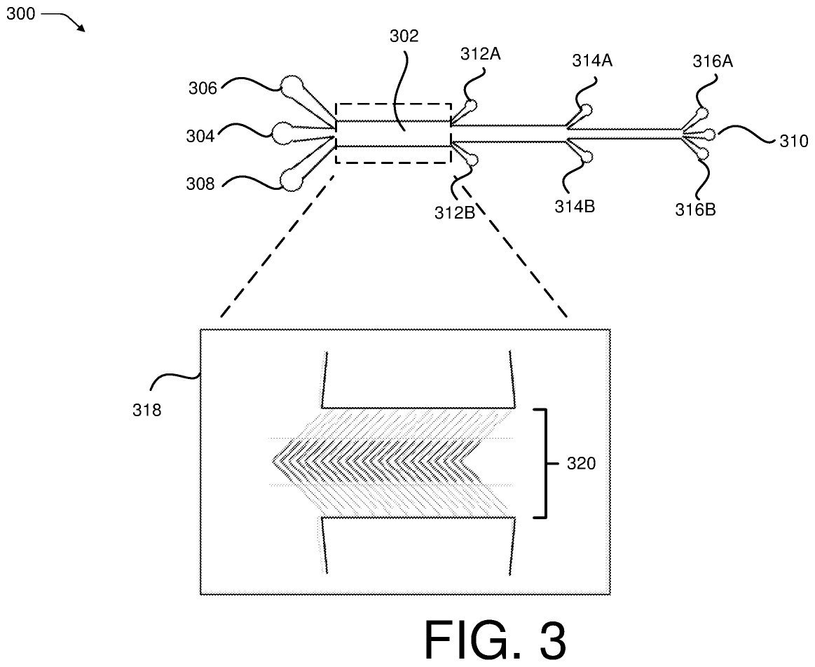

FIG. 3 illustrates a top view of another example microfluidic system 300 according to implementations of this disclosure.

Referring to FIG. 3, the microfluidic system 300 includes a microfluidic chamber 302, a plurality of inlets 304, 306, and 308, a plurality of outlets 310, 312A, 312B, 314A, 314B, 316A, and 316B. The microfluidic chamber 302 is in fluid communication with the plurality of inlets 304, 306, and 308 and the plurality of outlets 310, 312A, 312B, 314A, 314B, 316A, and 316B.

In implementations, the plurality of inlets includes a first inlet 304, a second inlet 306, and a third inlet 308. As an example, the first inlet 304 is a central inlet, configured to introduce the sample into the microfluidic chamber 302. The second inlet 306 and the third inlet 308 are side inlets configured to introduce sheath flows into the microfluidic chamber 302. For additional details of the inlets 304, 306, and 308, reference may be made to descriptions of the inlets 110, 112, and 114, which are not repeated here.

In implementations, the plurality of outlets includes a central outlet 310, a first pair of side outlets 312A and 312B, a second pair of side outlets 314A and 314B, and a third pair of side outlets 316A, and 316B. The central outlet 310, a first pair of side outlets 312A and 312B, a second pair of side outlets 314A and 314B, and a third pair of side outlets 316A, and 316B may be configured to collect different types of particles in the sample. For additional details of the outlets 310, 312A, 312B, 314A, 314B, 316A, and 316B, reference may be made to descriptions of the outlets 116, 118, and 120, which are not repeated here.

Tough FIG. 3 shows three inlets and seven outlets, there may be other numbers of inlets and outlets, and this disclosure is not limited thereto.

In implementations, the microfluidic system 300 includes at least one array of electrodes. Bubble 318 illustrates an expanded view of an example of an array of electrodes 320. For additional details of the array of electrodes 320 such as parameters and operations, reference may be made to descriptions of arrays 104, 106, and 108 of electrodes, which are not repeated here.

With the microfluidic system 300 that applies DEP field flow fractionation, particles in fluids can be sorted/separated based on differential DEP response characterizations of the particles. Sorting/enrichment of a target type of particles can be achieved by depleting other types of particles in the sample. Effectiveness and efficiency in liquid biopsy in the context of tumor-derived biomarkers detection can be improved. The problem in conventional techniques where the cell isolation of rare cells is time and labor intensive and harsh on the sample can be addressed.

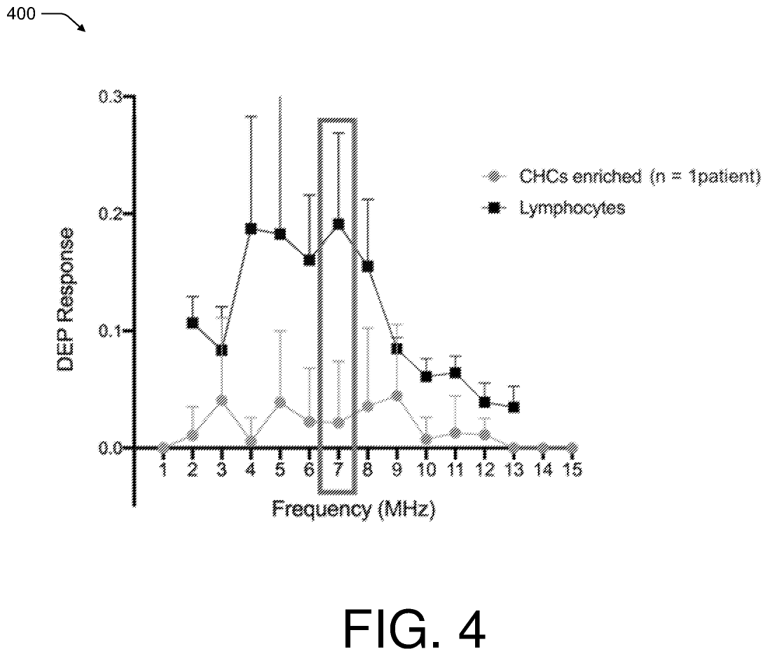

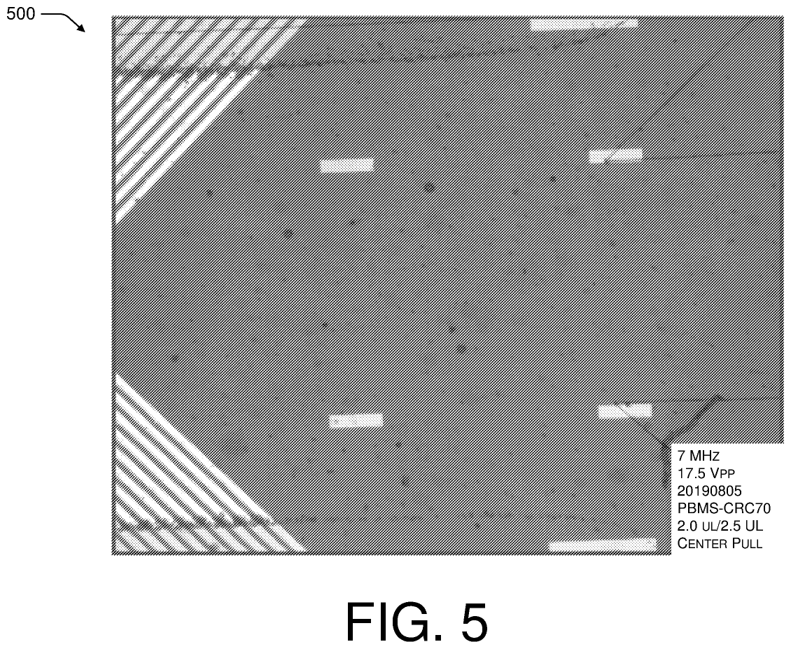

FIG. 4 illustrates a graph 400A showing DEP responses of CHCs and lymphocytes according to implementations of this disclosure. In FIG. 4, the horizontal axis represents frequency in MHZ, and the vertical axis represents DEP response, which is a relative distance where distance traveled in the y axis divided by the distance traveled in the x axis, and is a unitless value, FIG. 5 illustrates an image 500 showing the movement of lymphocytes.

Referring to FIG. 4, the frequency at which a respective array of electrodes operate was swept from 1 MHz to 13 MHz with an increment of 0.1 MHz at a constant voltage. Particles were collected at the outlets and analyzed by flow cytometry. In this example, the sample included CHCs and lymphocytes. CHCs showed less DEP response to lymphocyte which are the majority part of PBMC.

Referring to FIG. 5, the majority of cells (lymphocyte) in PBMC are sorted/pulled to the side outlets.

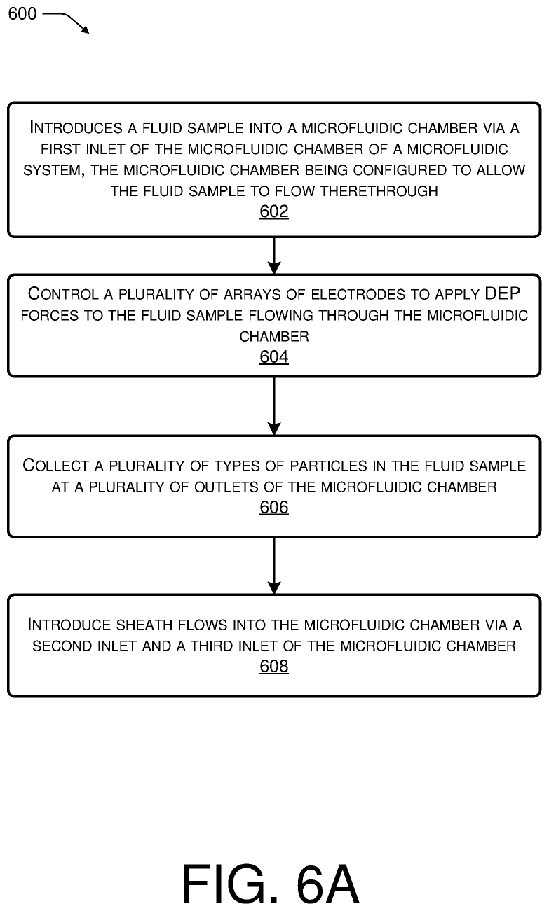

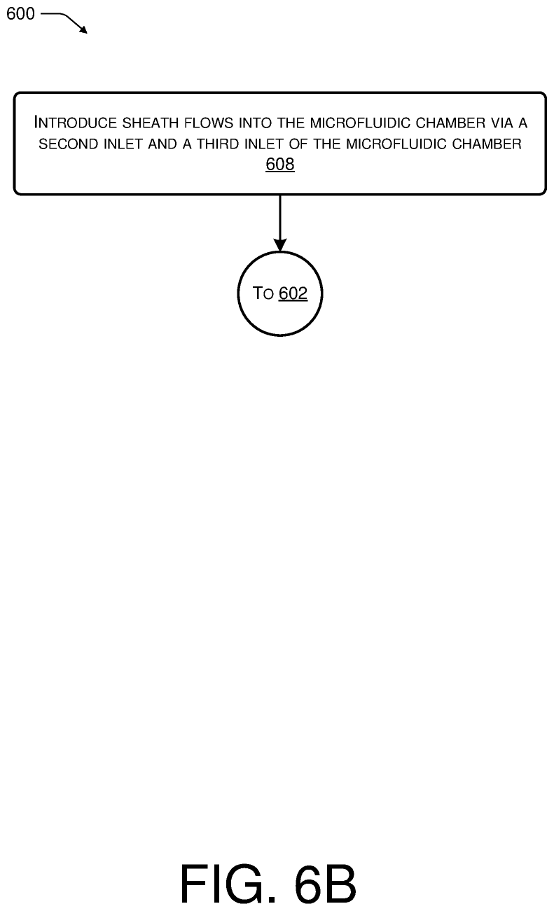

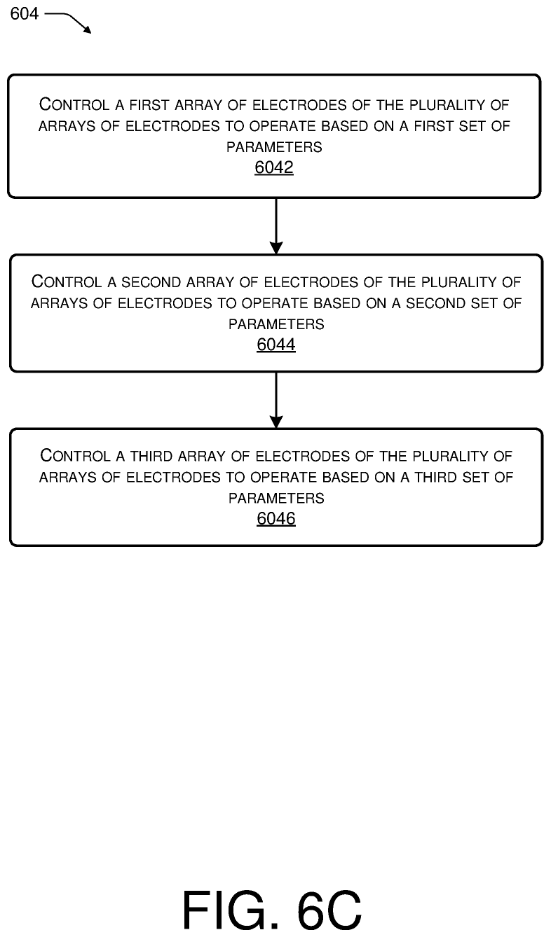

FIG. 6A, FIG. 6B, and FIG. 6C illustrate a flowchart of an example process 600 for sorting particles in fluids.

Referring to FIG. 6A, the process 600 includes the following.

At 602, a fluid sample is introduced into a microfluidic chamber via a first inlet of the microfluidic chamber of a microfluidic system. The microfluidic chamber is configured to allow the fluid sample to flow therethrough. Additional details of the microfluidic chamber are provided throughout this disclosure and are not repeated here.

At 604, at least one array of electrodes is controlled to apply DEP forces to the fluid sample flowing through the microfluidic chamber. The at least one array of electrodes is arranged on a substrate in the microfluidic chamber. In implementations, a respective electrode of the plurality of the arrays of electrodes is configured to have a V-shape. Additional details of the at least one array of electrodes are provided throughout this disclosure and are not repeated here.

At 606, a plurality of types of particles in the fluid sample is collected at a plurality of outlets of the microfluidic chamber. Additional details of the plurality of outlets are provided throughout this disclosure and are not repeated here.

Referring to FIG. 6B, the process 600 further includes the following.

At 608, sheath flows are introduced into the microfluidic chamber via a second inlet and a third inlet of the microfluidic chamber. Additional details of the plurality of inlets are provided throughout this disclosure and are not repeated here.

Referring to FIG. 6C, 604 includes the following.

At 6042, a first array of electrodes of the at least one array of electrodes is controlled to operate based on a first set of parameters. In implementations, the first set of parameters includes a first frequency between 1 Mhz and 20 Mhz and a first voltage between 5 V and 20 V.

At 6044, a second array of electrodes of the at least one array of electrodes is controlled to operate based on a second set of parameters. In implementations, the second set of parameters includes a second frequency between 4 Mhz and 9 Mhz and a second voltage between 5 V and 20 V.

At 6046, a third array of electrodes of the at least one array of electrodes is controlled to operate based on a third set of parameters. In implementations, the third set of parameters includes a third frequency between 9 Mhz and 14 Mhz and a third voltage between 5 V and 20 V.

In implementations, the fluid sample includes a first type of particle, a second type of particle, and/or a third type of particle. As an example, the first type of particle includes red blood cells (RBCs), the second type of particle includes lymphocytes, and the third type of particle includes circulating hybrid cells (CHCs).

### Representative Computer Architecture

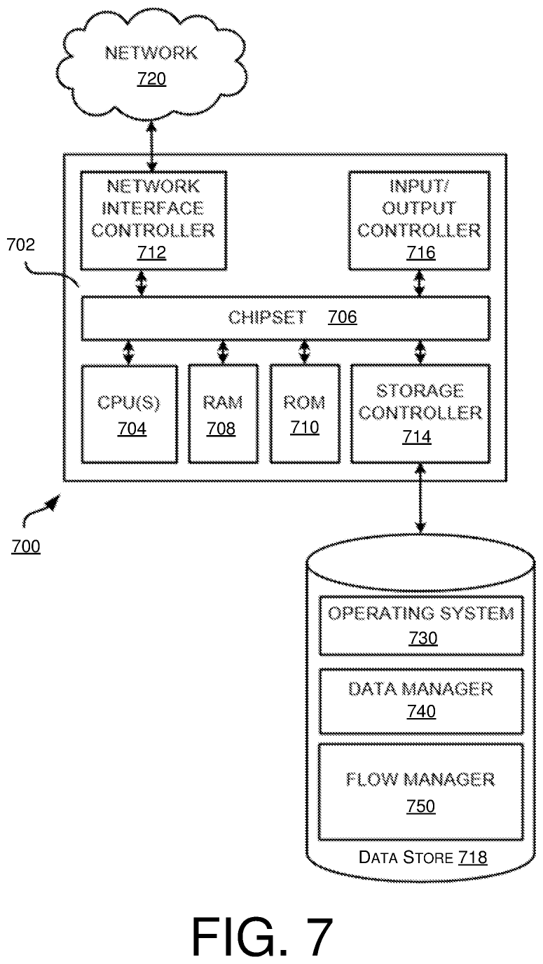

FIG. 7 illustrates an example computer architecture for a computer 700 capable of executing program components for performing operations and/or processes as described throughout this disclosure. The computer architecture shown in FIG. 7 illustrates a server computer, workstation, desktop computer, laptop, tablet, network appliance, digital cellular phone, smart watch, or other computing device, and may be utilized to execute any of the software components presented herein. The computer architecture shown in FIG. 7 may also be utilized to implement a computing device, or any other of the computing systems described herein.

The computer 700 includes a baseboard 702, or “motherboard,” which is a printed circuit board to which a multitude of components or devices may be connected by way of a system bus or other electrical communication paths. In one illustrative example, one or more central processing units (“CPUs”) 704 operate in conjunction with a chipset 706. The CPUs 704 may be standard programmable processors that perform arithmetic and logical operations necessary for the operation of the computer 700.

The CPUs 704 perform operations by transitioning from one discrete, physical state to the next through the manipulation of switching elements that differentiate between and change these states. Switching elements may generally include electronic circuits that maintain one of two binary states, such as flip-flops and electronic circuits that provide an output state based on the logical combination of the states of one or more other switching elements, such as logic gates. These basic switching elements may be combined to create more complex logic circuits, including registers, adders-subtractors, arithmetic logic units, floating-point units and the like.

The chipset 706 provides an interface between the CPUs 704 and the remainder of the components and devices on the baseboard 702. The chipset 706 may provide an interface to a RAM 708, used as the main memory in the computer 700. The chipset 706 may further provide an interface to a computer-readable storage medium such as a read-only memory (“ROM”) 710 or non-volatile RAM (“NVRAM”) for storing basic routines that help to startup the computer 700 and to transfer information between the various components and devices. The ROM 710 or NVRAM may also store other software components necessary for the operation of the computer 700 in accordance with the description herein.

The computer 700 may operate in a networked environment using logical connections to remote computing devices and computer systems through a network, such as the network 720. The chipset 706 may include functionality for providing network connectivity through a network interface controller (“NIC”) 712, such as a mobile cellular network adapter, Wi-Fi network adapter or gigabit Ethernet adapter. The NIC 712 is capable of connecting the computer 700 to other computing devices over the network 720. It should be appreciated that multiple NICs 712 may be present in the computer 700, connecting the computer to other types of networks and remote computer systems.

The computer 700 may be connected to a mass storage device 718 that provides non-volatile storage for the computer. The mass storage device 718 may store system programs, application programs, other program modules and data, which have been described in greater detail herein. The mass storage device 718 may be connected to the computer 700 through a storage controller 714 connected to the chipset 706. The mass storage device 718 may consist of one or more physical storage units.

The computer 700 may store data on the mass storage device 718 by transforming the physical state of the physical storage units to reflect the information being stored. The specific transformation of physical state may depend on various factors, in different implementations of this description. Examples of such factors may include, but are not limited to, the technology used to implement the physical storage units, whether the mass storage device 718 is characterized as primary or secondary storage and the like.

For example, the computer 700 may store information to the mass storage device 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 700 may further read information from the mass storage device 718 by detecting the physical states or characteristics of one or more particular locations within the physical storage units.

In addition to the mass storage device 718 described above, the computer 700 may have access to other computer-readable storage media to store and retrieve information, such as program modules, data structures, or other data. It will be appreciated by those skilled in the art that computer-readable storage media is any available media that provides for the non-transitory storage of data and that may be accessed by the computer 700.

By way of example, and not limitation, computer-readable storage media may include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The mass storage device 718 may store an operating system 730 utilized to control the operation of the computer 700. According to one example, the operating system comprises the LINUX operating system. According to another example, the operating system comprises the WINDOWS® SERVER operating system from MICROSOFT Corporation. According to another example, the operating system comprises the iOS operating system from Apple. According to another example, the operating system comprises the Android operating system from Google or its ecosystem partners. According to further examples, the operating system may comprise the UNIX operating system. It should be appreciated that other operating systems may also be utilized. The mass storage device 718 may store other system or application programs and data utilized by the computer 700, such as components that include the data manager 740, the flow manager 750 and/or any of the other software components and data described herein. The mass storage device 718 might also store other programs and data not specifically identified herein.

In one example, the mass storage device 718 or other computer-readable storage media is encoded with computer-executable instructions that, when loaded into the computer 700, create a special-purpose computer capable of implementing one or more of the embodiments or examples described herein. These computer-executable instructions transform the computer 700 by specifying how the CPUs 704 transition between states, as described above. According to one example, the computer 700 has access to computer-readable storage media storing computer-executable instructions which, when executed by the computer 700, perform one or more of the various processes described herein. The computer 700 might also include computer-readable storage media for performing any of the other computer-implemented operations described herein.

The computer 700 may also include one or more input/output controllers 716 for receiving and processing input from a number of input devices, such as a keyboard, a mouse, a touchpad, a touch screen, an electronic stylus, or other types of input device. Similarly, the input/output controller 716 may provide output to a display, such as a computer monitor, a flat-panel display, a digital projector, a printer, a plotter, or other types of output devices. It will be appreciated that the computer 700 may not include all of the components shown in FIG. 7, may include other components that are not explicitly shown in FIG. 7, or may utilize an architecture completely different than that shown in FIG. 7.

The Exemplary Embodiments and Example(s) below are included to demonstrate particular embodiments of the disclosure. Those of ordinary skill in the art should recognize in light of the present disclosure that many changes can be made to the specific embodiments disclosed herein and still obtain a like or similar result without departing from the spirit and scope of the disclosure.

### FIRST SET OF EXEMPLARY EMBODIMENTS

1. A system for sorting particles in fluids, including: a microfluidic chamber configured to allow fluid to flow therethrough, the microfluidic chamber including a substrate; at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and a controller configured to control the at least one array of electrodes.

2. The system of embodiment 1 (or any other system embodiment), wherein the microfluidic chamber further includes: a first inlet configured to introduce a sample into the microfluidic chamber; and a plurality of outlets configured to collect a plurality of types of particles in the sample.

3. The system of embodiment 2 (or any other system embodiment), further including a buffer exchange module configured to mix a buffer and the sample, the buffer exchange module being in fluid communication with the first inlet.

4. The system of embodiment 2 (or any other system embodiment), wherein the sample includes cells, synthetic micro-particles, nano-particles, viruses, bacteria, nucleic acids, and/or proteins.

5. The system of embodiment 2 (or any other system embodiment), wherein the sample includes prokaryotic cells and/or eukaryotic cells.

6. The system of embodiment 2 (or any other system embodiment), wherein the sample includes red blood cells (RBCs), lymphocytes, and/or circulating hybrid cells (CHCs).

7. The system of embodiment 2 (or any other system embodiment), wherein a ratio of a distance to a width of the microfluidic chamber is between 1:10 and 2:1, the distance being measured from the first inlet to an apex of a first array of electrodes of the at least one array of electrodes.

8. The system of embodiment 2 (or any other system embodiment), wherein the microfluidic chamber further includes a second inlet and a third inlet configured to introduce sheath flows into the microfluidic chamber.

9. The system of embodiment 8 (or any other system embodiment), wherein a ratio of a first width of the first inlet to a second width of the second inlet to a third width of the third inlet is between 0.5:1:1 and 2:1:1.

10. The system of embodiment 9 (or any other system embodiment), wherein the ratio of the first width of the first inlet to the second width of the second inlet to the third width of the third inlet is 1:1.5:1.5.

11. The system of embodiment 2 (or any other system embodiment), wherein the plurality of outlets include a first outlet, a second outlet, and a third outlet; and wherein a ratio of a fourth width of the first outlet to a fifth width of the second outlet to a sixth width of the third outlet is between 0.2:1:1 and 8:1:1.

12. The system of embodiment 11 (or any other system embodiment), wherein the ratio of the fourth width of the first outlet to the fifth width of the second outlet to the sixth width of the third outlet is 1.73:1:1.

13. The system of embodiment 2 (or any other system embodiment), wherein the buffer has a relatively low conductivity between 20 mS/m and 800 mS/m.

14. The system of embodiment 2 (or any other system embodiment), wherein the buffer includes at least one of dextrose, sucrose, water, bovine serum albumin, fetal bovine serum, sugars, proteins, amino acids, salts, and/or lipids.

15. The system of embodiment 1 (or any other system embodiment), wherein a length of the microfluidic chamber is between 10 mm and 50 mm.

16. The system of embodiment 1 (or any other system embodiment), wherein a width of the microfluidic chamber is between 0.5 mm and 5 mm.

17. The system of embodiment 1 (or any other system embodiment), wherein a height of the microfluidic chamber is between 20 μm and 100 μm.

18. The system of embodiment 1 (or any other system embodiment), wherein a first array of electrodes of the at least one array of electrodes is configured to operate at a frequency between 1 Mhz and 20 Mhz and a voltage between 5 Volt (V) and 20 V.

19. The system of embodiment 1 (or any other system embodiment), wherein a second array of electrodes of the at least one array of electrodes is configured to operate at a frequency between 4 Mhz and 9 Mhz and a voltage between 5 V and 20 V.

20. The system of embodiment 1 (or any other system embodiment), wherein a third array of electrodes of the at least one array of electrodes is configured to operate at a frequency between 9 Mhz and 14 Mhz and a voltage between 5 V and 20 V.

21. The system of embodiment 1 (or any other system embodiment), wherein a respective array of electrodes of the at least one array of electrodes includes 60 pairs of interdigitated electrodes.

22. The system of embodiment 1 (or any other system embodiment), wherein a total length of the at least one array of electrodes is between 65% and 95% of a length of the microfluidic chamber.

23. The system of embodiment 1 (or any other system embodiment), wherein a length of a respective array of electrodes of the at least one array of electrodes is between 5 mm and 50 mm.

24. The system of embodiment 1 (or any other system embodiment), wherein a first gap is arranged between a first array of electrodes and a second array of electrodes of the at least one array of electrodes, and a first width of the first gap is between 250 μm to 1 mm.

25. The system of embodiment 24 (or any other system embodiment), wherein a second gap is arranged between a second array of electrodes and a third array of electrodes of the at least one array of electrodes, and a second width of the second gap is between 250 μm to 1 mm.

26. The system of embodiment 1 (or any other system embodiment), wherein a width of the respective electrode is between 10 μm and 50 μm.

27. The system of embodiment 1 (or any other system embodiment), wherein a spacing is arranged between two adjacent electrodes of a respective array of electrodes of the at least one array of electrodes, and a ratio of a width of the respective electrode to a width of the spacing is between 1:0.5 and 1:1.5.

28. The system of embodiment 1 (or any other system embodiment), wherein an edge portion of the respective electrode is covered with insulating material.

29. The system of embodiment 28 (or any other system embodiment), wherein a width of the edge portion of the respective electrode covered with the insulating material is between 5% and 15% of a width of the microfluidic chamber.

30. The system of embodiment 1 (or any other system embodiment), wherein a distance between an endpoint of the respective electrode and a sidewall of the microfluidic chamber is between 50 μm and 300 μm.

31. The system of embodiment 1 (or any other system embodiment), wherein the respective electrode includes a first segment and a second segment connected to the first segment at an apex, the first segment and the second segment forming the V-shape, an angle between the first segment and the second segment being between 30 degrees and 60 degrees.

32. The system of embodiment 1 (or any other system embodiment), wherein the substrate and the at least one array of electrodes constitute a chip, and no overall coating is provided on the chip.

33. A method for sorting particles in fluids, including: introducing a fluid sample into a microfluidic chamber via a first inlet of the microfluidic chamber of a microfluidic system, the microfluidic chamber being configured to allow the fluid sample to flow therethrough; controlling at least one array of electrodes to apply dielectrophoretic (DEP) forces to the fluid sample flowing through the microfluidic chamber, wherein the at least one array of electrodes are arranged on a substrate in the microfluidic chamber, and a respective electrode of the plurality of the arrays of electrodes is configured to have a V-shape; and collecting a plurality of types of particles in the fluid sample at a plurality of outlets of the microfluidic chamber.

34. The method of embodiment 33 (or any other method embodiment), wherein controlling the at least one array of electrodes includes: controlling a first array of electrodes of the at least one array of electrodes to operate based on a first set of parameters; and controlling a second array of electrodes of the at least one array of electrodes to operate based on a second set of parameters.

35. The method of embodiment 34 (or any other method embodiment), wherein the first set of parameters includes a first frequency between 1 Mhz and 20 Mhz and a first voltage between 5 V and 20 V.

36. The method of embodiment 34 (or any other method embodiment), wherein the second set of parameters includes a second frequency between 4 Mhz and 9 Mhz and a second voltage between 5 V and 20 V.

37. The method of embodiment 33 (or any other method embodiment), wherein controlling the at least one array of electrodes further includes: controlling a third array of electrodes of the at least one array of electrodes to operate based on a third set of parameters.

38. The method of embodiment 37 (or any other method embodiment), wherein the third set of parameters includes a third frequency between 9 Mhz and 14 Mhz and a third voltage between 5 V and 20 V.

39. The method of embodiment 33 (or any other method embodiment), further including: introducing sheath flows into the microfluidic chamber via a second inlet and a third inlet of the microfluidic chamber.

40. The method of embodiment 33 (or any other method embodiment), wherein the fluid sample includes cells, synthetic micro-particles, nano-particles, viruses, bacteria, nucleic acids, and/or proteins.

41. The method of embodiment 33 (or any other method embodiment), wherein the fluid sample includes prokaryotic cells and/or eukaryotic cells.

42. The method of embodiment 33 (or any other method embodiment), wherein the fluid sample includes a first type of particle, a second type of particle, and/or a third type of particle.

43. The method of embodiment 42 (or any other method embodiment), wherein the first type of particle includes red blood cells (RBCs), the second type of particle includes lymphocytes, and the third type of particle includes circulating hybrid cells (CHCs).

44. A computer-readable storage medium storing computer-readable instructions executable by one or more processors, that when executed by the one or more processors, cause the one or more processors to perform operations including: introducing a fluid sample into a microfluidic chamber via a first inlet of the microfluidic chamber, the microfluidic chamber being configured to allow the fluid sample to flow therethrough; controlling at least one array of electrodes to apply dielectrophoretic (DEP) forces to the fluid sample flowing through the microfluidic chamber, wherein the at least one array of electrodes are arranged on a substrate in the microfluidic chamber, and a respective electrode of the at least one array of electrodes is configured to have a V-shape; and collecting a plurality of types of particles in the fluid sample at a plurality of outlets of the microfluidic chamber.

45. The computer-readable storage medium of embodiment 44 (or any other computer-readable storage medium embodiment), wherein controlling the at least one array of electrodes includes: controlling a first array of electrodes of the at least one array of electrodes to operate at a first set of parameters; and controlling a second array of electrodes of the at least one array of electrodes to operate at a second set of parameters.

46. The computer-readable storage medium of embodiment 45 (or any other computer-readable storage medium embodiment), wherein the first set of parameters includes a first frequency between 1 Mhz and 20 Mhz and a first voltage between 5 V and 20 V.

47. The computer-readable storage medium of embodiment 45 (or any other computer-readable storage medium embodiment), the second set of parameters includes a second frequency between 4 Mhz and 9 Mhz and a second voltage between 5 V and 20 V.

48. The computer-readable storage medium of embodiment 44 (or any other computer-readable storage medium embodiment), wherein controlling the at least one array of electrodes further includes: controlling a third array of electrodes of the at least one array of electrodes to operate at a third set of parameters.

49. The computer-readable storage medium of embodiment 48 (or any other computer-readable storage medium embodiment), wherein the third set of parameters includes a third frequency between 9 Mhz and 14 Mhz and a third voltage between 5 V and 20 V.

### SECOND SET OF EXEMPLARY EMBODIMENTS

1. A system for sorting particles in fluids, including: a microfluidic chamber configured to allow fluid to flow therethrough, the microfluidic chamber including a substrate; at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and a controller configured to control the at least one array of electrodes; wherein the substrate and the at least one array of electrodes constitute a chip, and no overall coating is provided on the chip.

2. A system for sorting particles in fluids, including: a microfluidic chamber configured to allow fluid to flow therethrough, the microfluidic chamber including a substrate; at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and a controller configured to control the at least one array of electrodes; wherein a total length of the at least one array of electrodes is between 65% and 95% of a length of the microfluidic chamber.

3. A system for sorting particles in fluids, including: a microfluidic chamber configured to allow fluid to flow therethrough, the microfluidic chamber including a substrate; at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and a controller configured to control the at least one array of electrodes; wherein an edge portion of the respective electrode is covered with insulating material, and a width of the edge portion of the respective electrode covered with the insulating material is between 5% and 15% of a width of the microfluidic chamber.

4. A system for sorting particles in fluids, including: a microfluidic chamber configured to allow fluid to flow therethrough, the microfluidic chamber including a substrate; at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and a controller configured to control the at least one array of electrodes; wherein a total length of the at least one array of electrodes is between 65% and 95% of a length of the microfluidic chamber.

### Example 1

This Example describes label-free enrichment of rare unconventional circulating neoplastic cells using a microfluidic dielectrophoretic sorting device, as well as design of that device. At least some of the results discussed in this Example were published as Mira et al., Commun Biol 4, 1130 Sep. 24, 2021, doi.org/10.1038/s42003-021-02651-8.

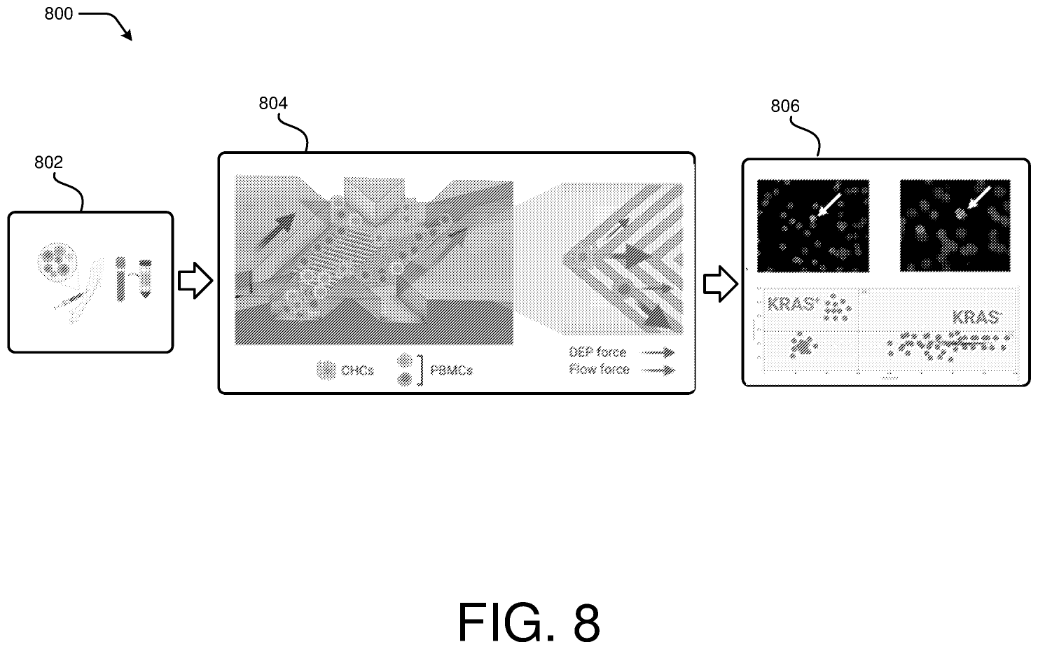

Hereinafter, Example 1 is described with reference to FIGS. 8-20.

### Design & Validation Strategy of Microfluidic System

### Design

FIG. 8 illustrates an example workflow 800 for label-free enrichment of unconventional circulating neoplastic cells (such as CHCs). Referring to FIG. 8, workflow 800 includes the following.

At 802, whole blood was collected from a patient. At 804, a microfluidic system according to implementations of this disclosure was used to sort/enrich a target type of particle/cell (such as CHCs) in the sample. At 806, downstream analysis was conducted.

The concept of enriching a target cell population by depleting non-relevant cells is shown schematically in FIG. 8. First, the sample is infused into the microfluidic DEP sorting device, composed of a microfluidic channel and interdigitated electrode arrays. The microfluidic device was manufactured by standard photolithographic and lift-off techniques where a silicon substrate was patterned with an interdigitated electrode layer and a polydimethylsiloxane (PDMS) layer was bonded on top to form a fluidic channel. To allow cells throughout the channel's height to be acted upon by DEP forces, the chamber height was designed to be 25 μm or approximately twice the average size of PBMCs. Under continuous flow the sample is centrally confined by two sheath flows providing small variation of initial speed and position. The interdigitated electrodes were designed to have a width and spacing of 35 μm, approximately 2-3 times the size of PBMCs, to minimize cells being captured on the electrodes by DEP forces (FIG. 1A). The V-shape electrode geometry was designed to deflect PBMCs in a high cell density environment by utilizing DEP forces to deflect cells along the electrodes while flow forces direct cells along the length of the device (Nie et al., Sens Actuators B: Chem, 327:128873, 2021, doi: 10.1016/j.snb.2020.128873; Wu et al., Anal. Chem., 90(19): 11461-11469, 2018, doi: 10.1021/acs.analchem.8b02628; Song et al., Lab Chip, 15(5): 1320-1328, 2015, doi: 10.1039/c4lc01253d). Cells experiencing strong DEP forces are depleted to the side outlets, while less responsive cells are enriched in the center channel (FIG. 8). In order to maximize the DEP response and minimize electrode corrosion, a low conductive buffer at 145 mS/m (approximately 0.1×PBS) was used during cell enrichment processing for both the sample and sheath inlets. The buffer was chosen to balance cell viability, DEP reactivity, and electrode corrosion (Smith et al., Sci Rep, 7(1): 1-15, 2017, doi: 10.1038/srep41872; Jiang et al., Biomicrofluidics, 13(6): 064111, 2019, doi: 10.1063/1.5128797). For ease of use and rapid troubleshooting the complete setup was placed under a microscope for continuous viewing where the fluidic channel is visible under a standard 5× objective lens. This setup allows for sample compatibility with genotypic or phenotypic downstream analysis (FIG. 8) which can be helpful for understanding cellular clinical significance (Cheng et al., Micromachines, 11(8): 774, 01, 2020, doi: 10.3390/MI11080774).

### Validation

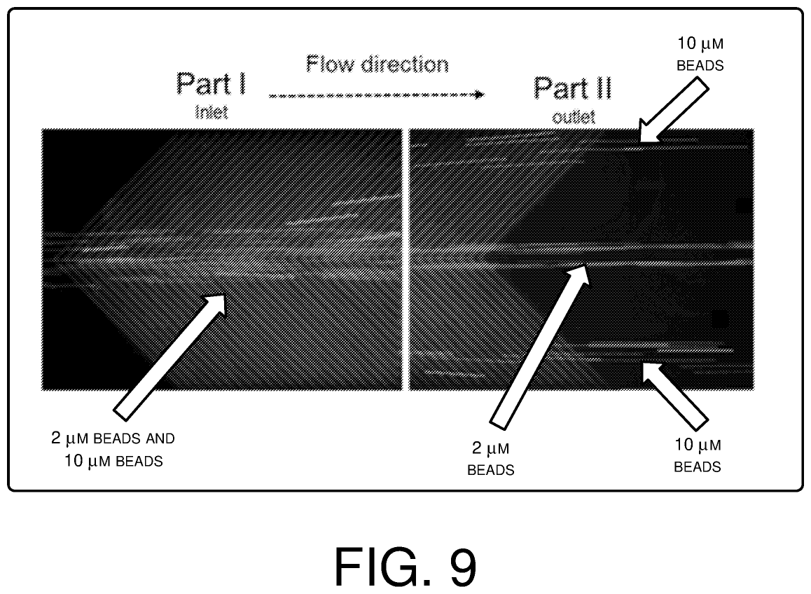

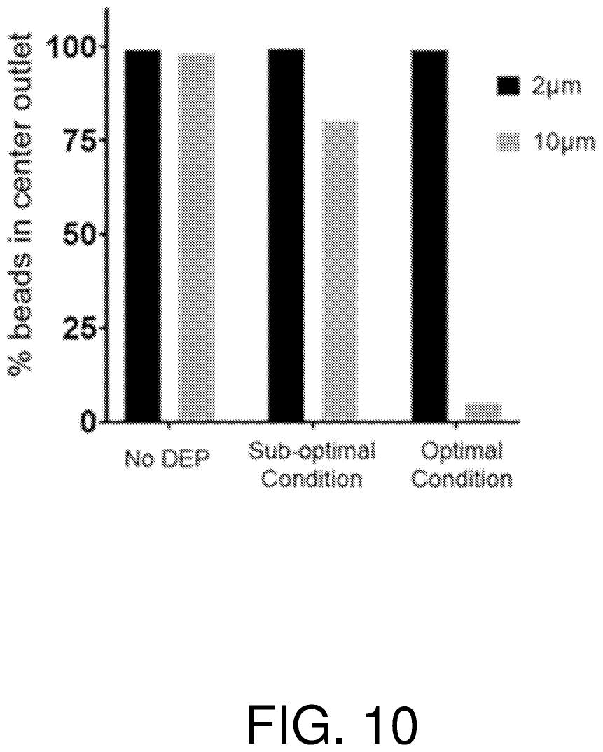

FIG. 9 illustrates fluorescent images of the microfluidic chamber showing differential responses of different types of polystyrene beads with 10 μm (green) and 2 μm (blue) diameters. FIG. 10 illustrates percent of beads collected from the center outlet at an optimal condition (5 MHZ), a sub-optimal condition (300 kHz), and with no applied DEP.

To demonstrate the concept of enriching by depleting a target population, a sample mix composed of 2 μm (blue) and 10 μm (green) fluorescent polystyrene beads of identical chemistry was used (FIG. 9 and FIG. 10). The sample mix was introduced to the inlet of the microfluidic DEP sorting device with AC voltage applied to the interdigitated electrodes, and particle movement was monitored by live imaging. The optimal condition is defined as the parameters where one type of particle is enriched by the effect of depleting the other. To find this condition, the frequency was swept from 0.1 MHz to 10 MHz at 0.1 MHz increments at constant voltage. Particles were collected at the outlets and analyzed by flow cytometry.

Under the optimal frequency, both bead populations were closely aligned with the center of the channel while near the sample inlet (FIG. 9, Part I), however only the 10 μm beads were displaced further downstream by DEP forces revealing particle trajectory bias over time and space (FIG. 9, part II). Under this condition, 95% of the 10 μm beads were depleted from the center due to the application of strong positive DEP forces, while less than 1% of the 2 μm beads were depleted to the sides (FIG. 10). FIG. 10 also shows an example at one of the sub-optimal frequencies that only 19.5% of 10 μm were depleted, suggesting that the magnitude of the DEP force was smaller than the dominant flow forces. To confirm that DEP forces were the primary driver of bead depletion, the device was run without applied DEP and resulted in 99% of both bead populations remaining in the center unaffected by drift. This workflow demonstrated that depletion of one population by DEP can result in collection of targets with high purity under proper working parameters. To understand how this applies to a complex biological sample mix, this process was next tested on PBMCs and cell lines.

### Optimization of PBMC Depletion and Hybrid Cell Line Enrichment

### PBMC DEP Response Characterization

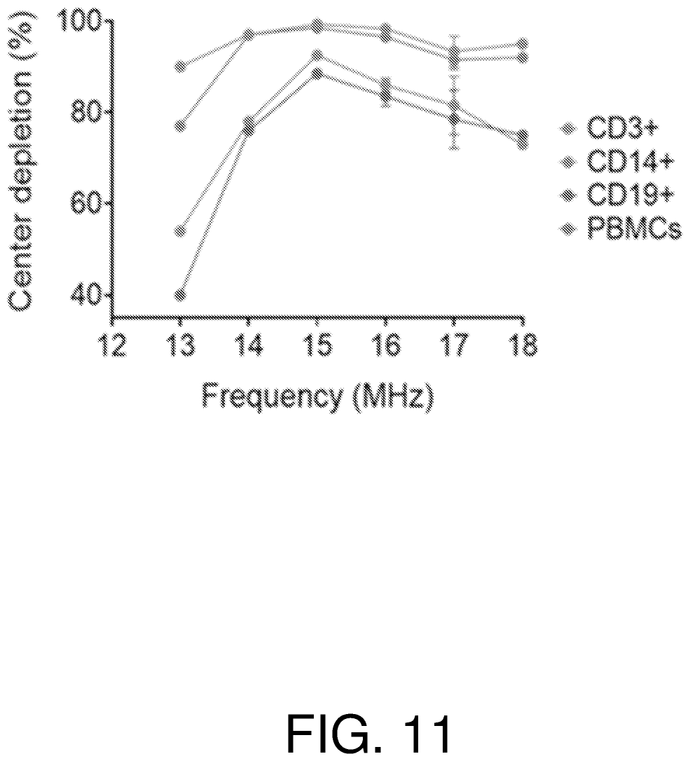

FIG. 11 illustrates PBMC subpopulation analysis as presented by depletion of CD3+, CD14+, CD19+, and CD45+ cells across frequencies, 13 MHz to 18 MHz at a constant 8 V by flow cytometry. In FIG. 11, the vertical axis represents the center depletion of cells, and the horizontal axis represents the frequency at which the electrodes operate.

As DEP conditions can be optimized to separate discrete physiologic objects, the optimal condition where hybrid cells could be enriched from PBMCs was tested. Cells are biologic entities, thus their conductivity, permittivity, and physiological state are the main drivers of differential DEP response (Crane et al., J Theor Biol, 37(1): 15-41, 1972, doi: 10.1016/0022-5193(72) 90113-0). Healthy PBMCs are composed of heterogeneous populations, but tend to be relatively similar in nature across individuals, therefore healthy PBMCs act as an ideal object to be optimized for depletion. PBMCs are mainly comprised of lymphocytes, monocytes, and granulocytes. Of these, T-cells represent the majority (70-80%) of the total cell number, therefore it was hypothesized that depletion of T-cells would be the primary contributor of neoplastic cell enrichment. First, to understand the DEP response of PBMCs as a collective of cells and as individual subpopulations, workflow using PBMCs isolated from whole blood (n=5) from healthy subjects was conducted. PBMCs were diluted in DEP buffer (1×10⁷ cells/mL), and 1×10⁶ cells were loaded into the central inlet for each parameter, then subjected to device processing for at least 30 minutes. Cells were not responsive to DEP at low frequencies, thus analyses were focused to when cells were visually responsive, between 13 and 17 MHz at a constant voltage of 8 V. This voltage was selected because cells were minimally reactive below 7 V but were trapped on the electrodes at voltages greater than 9 V. For each frequency, cells were collected from all three outlets then stained with antibodies against CD45 (pan-leukocyte), CD3 (T-cell receptor), CD14 (macrophage), and CD19 (pan B-cell) (FIG. 11). Depletion of each cell type was calculated by flow cytometry analysis of the outlets where the percent of CD3+, CD14+, or CD19+ cells in the side channels was divided by the percent of the cell of interest from the total cells processed (CD45+). A similar trend was observed for all populations, where 15 MHz resulted in maximum depletion from the center channel, which was most pronounced for CD3+ cells (99.3%), followed by CD14+ cells (92.5%), and CD19+ cells (88.5%). Ultimately, only 1.5% of the initial number of PBMCs (CD45+) were collected in the central outlet (FIG. 11). Of the subpopulations, it was found that CD3+ T-cells were the most responsive and had similar depletion levels between 14, 15, and 16 MHz at 97%, 99.3%, and 98.3%, respectively. In contrast, depletion of CD19+ and CD14+ cells significantly changed from 13 MHz to 15 MHZ, suggesting that these cell populations were more sensitive to specific DEP parameters. Previous findings by Gascoyne et al. were corroborated that different cell types have different DEP response profiles (Shim et al., Biomicrofluidics, 7(1), 2013, doi: 10.1063/1.4774307; Gascoyne et al., Electrophoresis, 34(7): 1042-1050, 2013, doi: 10.1002/elps.201200496; Gascoyne et al., Cancers (Basel), 6(1): 545-579, 2014, doi: 10.3390/cancers6010545). Not only was depletion of PBMCs observed, it was found that the composition of PBMCs changed post-depletion e.g. there was 7.3-fold and 4.6-fold enrichment of CD19+ and CD14+ cells in the center channel, respectively. These results suggest that across PBMC phenotypes there is a cell type-dependent DEP response that supports their differential separation and that depletion of CD3+ cells could drive enrichment of rare cells.

### In-Vitro CHC DEP Response Characterization

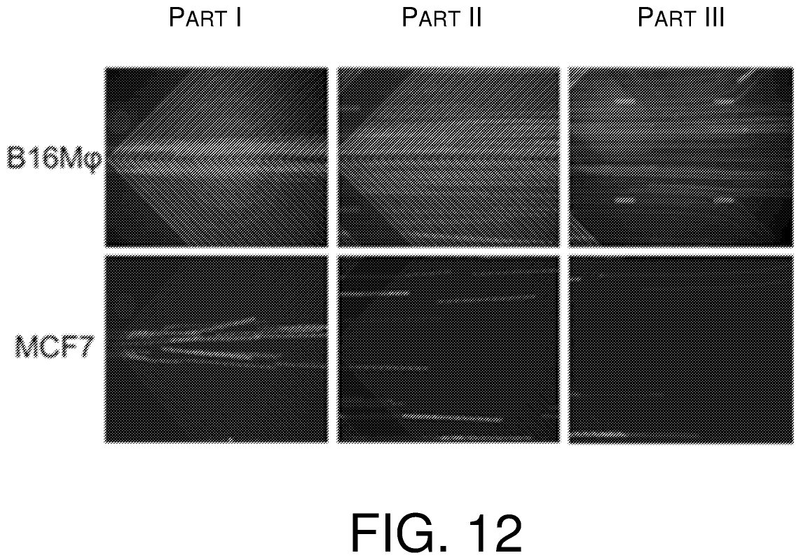

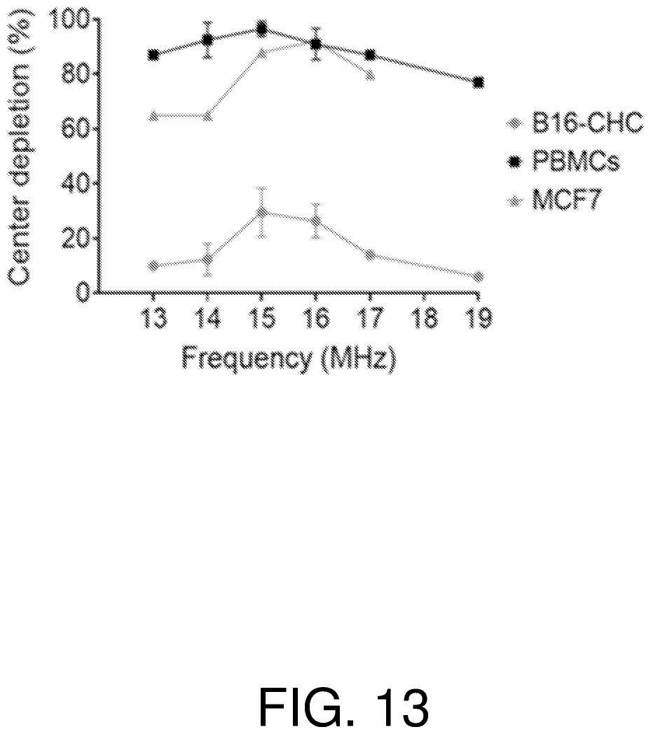

FIG. 12 illustrates fluorescent images near the inlet (Part I), at the center between batches of electrodes (Part II), and close to the outlet (Part III) of the microfluidic channel revealed depletion of MCF7 (green) and less reactive B16Mφ (red) at 15 MHz and 8 V. FIG. 13 illustrates percent depletion of B16Mφ, MCF7, and PBMCs from the center outlet across frequencies, 13 MHz to 19 MHz, at a constant 8 V by flow cytometry.

Next, to understand the DEP response of malignant cells, an established in-vitro hybrid cell line generated through the fusion of B16F10 and bone marrow-derived macrophages (B16Mφ-RFP) was selected as a model of CHCs (Gast et al., Sci Adv, 4(9): 7828-7840, 2018, doi: 10.1126/sciadv.aat7828; Sinkala et al., Nat Commun, 8(1): 1-12, 2017, doi: 10.1038/ncomms14622). In addition, a breast cancer cell line, MCF7, was used as a surrogate of traditional CTCs. Previously, Gast et al. characterized the phenotypic hybrid nature of in vitro derived CHCs. Conveniently, these hybrids co-expressed nuclear RFP and cytoplasmic YFP facilitating their differentiation from the MCF7-GFP cells by flow cytometry (Aguirre et al., Oncoimmunology, 9(1), 2020, doi: 10.1080/2162402X.2020.1773204). To optimize conditions for hybrid cell enrichment, cancer cells were diluted in DEP buffer at 1×10⁷/mL and only 1×10⁶ cells were loaded into the microfluidic DEP sorting device for each parameter. To visualize cancer cell DEP response, fluorescent images were taken at three locations (FIG. 12), near the inlet (part I), the middle after the first batch of electrodes (part II), and close to the outlets (part III). At 15 MHz/8 V, both B16Mφ-RFP and MCF7-GFP were aligned with the central inlet flow. As the cells flowed through the device, the majority of MCF7 cells depleted to the sides while the majority of B16Mφ remained in the center. To quantify each sorting parameter, cells were processed in the device for at least 30 minutes and all the outlets were analyzed by flow cytometry. Across all tested frequencies MCF7 cells were more responsive than B16Mφ cells. MCF7 cells had a minimum response at 13 MHz where 65% of the cells were depleted and a maximum response at 16 MHz where 92% were depleted to the sides (FIG. 12). In contrast, the minimum DEP response for B16Mφ was at 19 MHz where only 6% of the cells were depleted and the maximum DEP response was at 15 MHz where only 29.5% of cells were depleted suggesting that hybrid cells have a unique non-responsive DEP profile (FIG. 13). In parallel, the DEP response of healthy PBMCs (CD45+) was analyzed under the same conditions. Again, PBMCs were highly responsive across all frequencies with a minimum response at 19 MHz with 77% of the cells depleted and a maximum response at 15 MHz with 96.5% of the cells depleted from the center channel (FIG. 13).

Overall, it was found that a larger differential response between B16Mφ-RFP and PBMCs as compared to MCF7-GFP cells and PBMCs despite their close proximity in size to PBMCs suggesting that label free size-independent enrichment was possible within the workflow. This also suggests that B16Mφ-RFP cells inherently have different dielectric properties likely resulting from their hybrid nature. Although numerous studies focus on CTC enrichment and isolation, these strategies rely on either the inherent large size of CTCs or specific membrane protein expression. CHCs are a promising alternative as they are more abundant than CTCs, but there is a lack of technologies focused on their enrichment, a critical factor in developing CHCs as a cancer biomarker. This data highlights the potential of using DEP to enrich for CHCs and potentially other rare cellular biomarkers that are difficult to differentiate phenotypically.

Hybrid Cell Line Spiked into Healthy Peripheral Blood

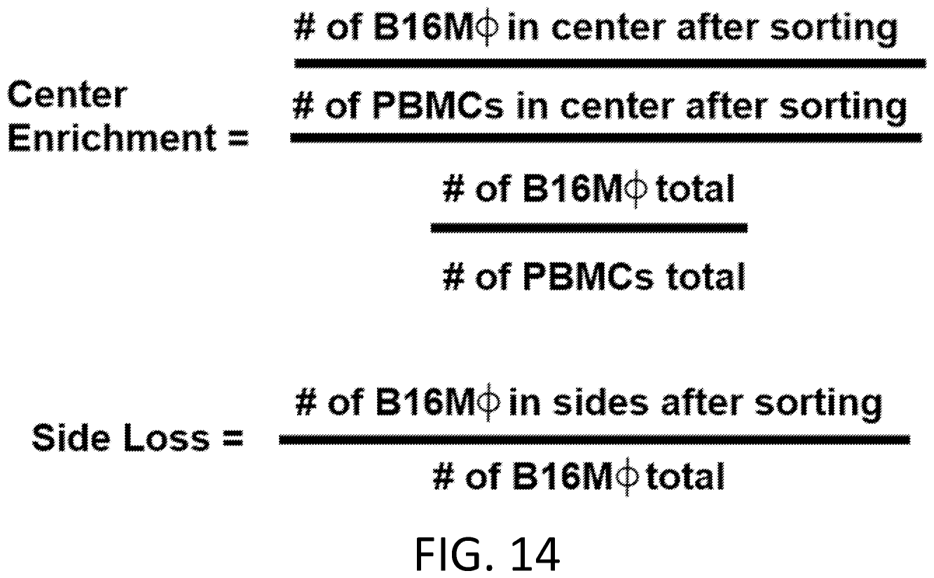

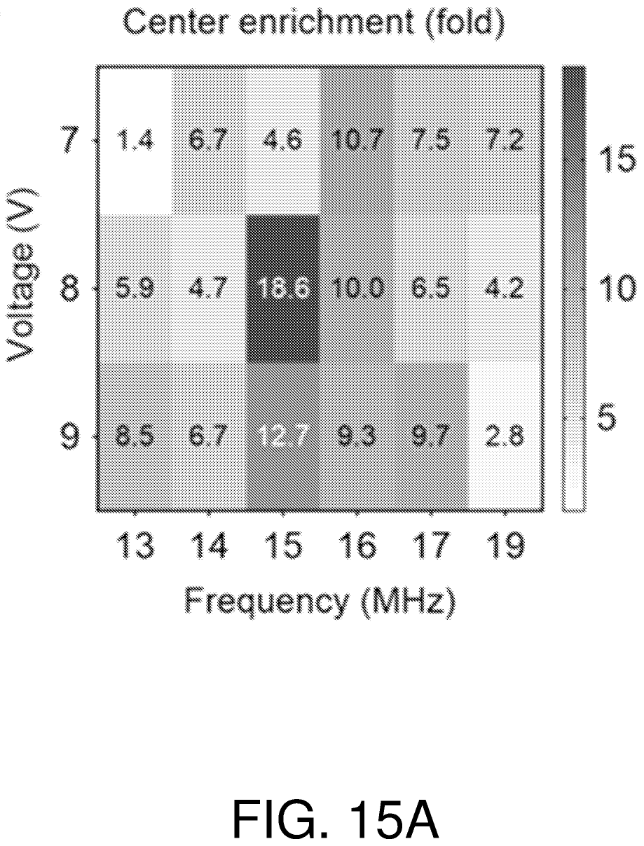

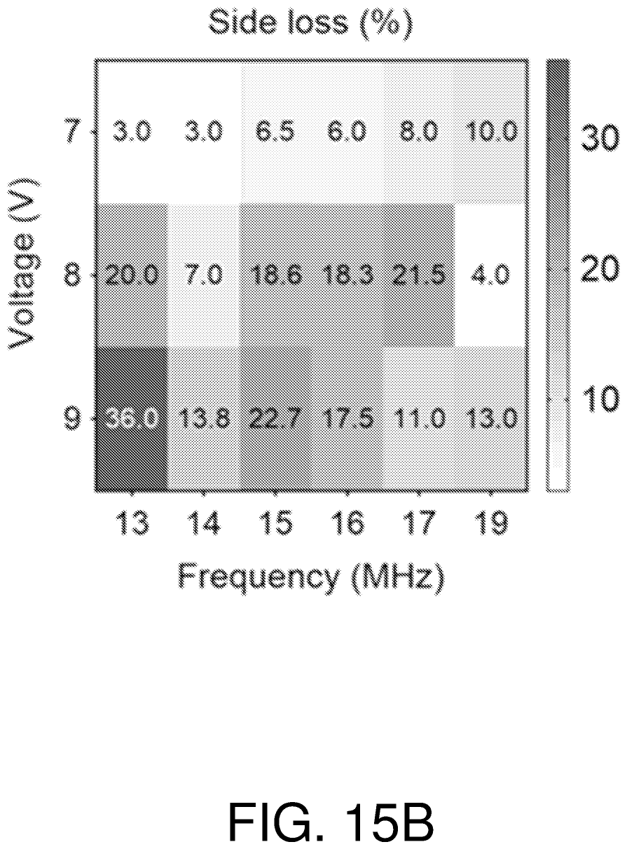

FIG. 14 illustrates equations for center enrichment and side loss used for FIG. 15A and FIG. 15B. FIG. 15A illustrates center enrichment heatmap with voltage (V) in the y axis and frequency (MHZ) in the x axes (n=1-5). FIG. 15B illustrates percentage side loss heatmap with voltage (V) in the y axis and frequency (MHZ) in the x axes (n=1-5).

A number of technologies to study rare cells rely on isolation of single cells, which is challenging. Recently, the development of high-throughput single cell technologies allows analysis of thousands of cells and demonstrates the need for rare cell enrichment rather than pure isolation. For most enrichment strategies there is a tradeoff between total enrichment and overall cellular biomarker loss during processing due to a limit of detection (LOD) threshold. To find the optimal frequency and voltage parameters to enrich for CHCs, the enrichment of B16Mφ-RFP cells from PBMCs was evaluated. PBMCs that were isolated from healthy subjects were spiked with 50,000 B16Mφ cells (50,000 per 1×10⁶ PBMCs), then subjected to DEP for at least 30 minutes, and analyzed for cells types isolated from all outlets by flow cytometry. Enrichment of hybrids in the center channel and depletion in the side channels was calculated using flow cytometric data for each outlet (see equations shown in FIG. 2D). This process was repeated for six frequencies, from 13-18 MHz and three voltages for each frequency, 7-9 V. A heatmap was generated to assess center channel hybrid enrichment (fold change) and side channel hybrid loss (percentage loss) taking into account both the frequency and voltage applied to the device (FIG. 15A and FIG. 15B). The enrichment varied from 1.4-fold and 2.8-fold at 13 MHz/7 V and 19 MHz/9 V, respectively, to 18.6-fold and 12.7-fold at 15 MHz/8 V and 15 MHz/9 V, respectively. The highest B16Mφ enrichment identified was 18.6-fold (n=5) at 15 MHz/8 V (FIG. 15A). The voltage was a strong driver of the magnitude of DEP response with greater loss of B16Mφ cells to the sides at higher voltages (FIG. 15B). For example, at 15 MHz, there was 6.5% loss to the sides at 7 V, 18.6% at 8 V, and 22.7% at 9 V. Overall, it was found that 15 MHz and 8 V provided optimal DEP parameters for B16Mφ hybrid enrichment and potentially for patient-derived CHCs. These trends observed follow previously describe bell-shaped DEP response curves (Jiang et al., Micromachines, 11(12): 1121, 2020, doi: 10.3390/mi11121121). In these models as well as in the data presented here, a narrow range of maximum DEP response can be appreciated. Overall, this unique strategy to deplete healthy PBMCs from the sample underlies enrichment of the target tumor cell population.

According to current literature there are approximately 30 CHCs per 500,000 PBMCs in PDAC patients representing only 0.006% of total cells in blood (Dietz et al., bioRxiv, 2021.03.11.434896, 2021, doi: 10.1101/2021.03.11.434896). This overall rarity highlights a clear need for CHC enrichment for downstream analyses such as mutational profiling using ddPCR or genomic surveying using single cell sequencing, both of which have a limit of detection (LOD) of 0.1% (Morita et al., Nat Commun, 11(1): 1-17, 2020, doi: 10.1038/s41467-020-19119-8; Dong et al., Sci Rep, 8(1): 9650, 2018, doi: 10.1038/s41598-018-27368-3; Mission Bio. Performance of the Tapestri® Platform for Single-Cell Targeted DNA Sequencing, Retrieved from missionbio.com/wp-content/uploads/2019/10/WhitePaper_MissionBio_TapestriPlatform_RevA.pdf; Azuara et al., Clin. Chem., 58(9): 1332-1341, 2012, doi: 10.1373/clinchem.2012.186577. With 18.6-fold enrichment using the described workflow, the microfluidic DEP sorting device described could enrich above 0.1% LOD suggesting there is utility targeting the depletion of healthy PBMCs to facilitate a more comprehensive understanding of poorly understood circulating pathogenic cells.

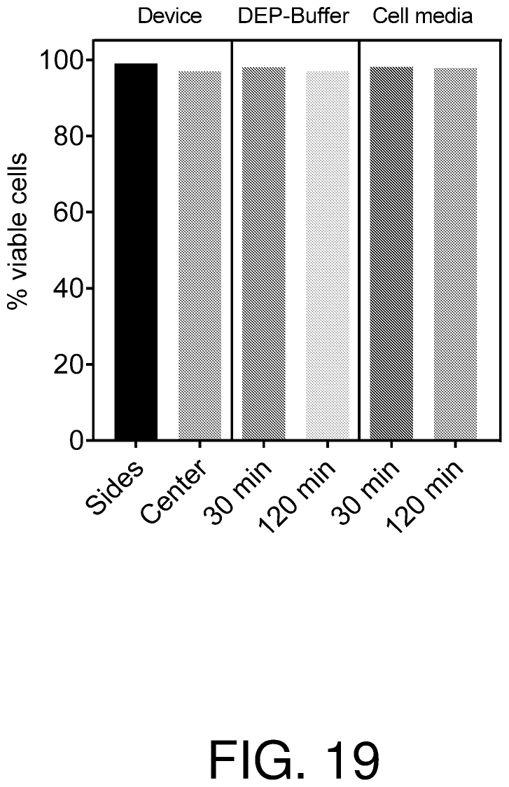

Finally, since a strong electric field can induce cell death, which would disrupt downstream analyses, cell viability was assessed throughout the DEP workflow. Non-viable cells can lead to aggregation and clogging, which reduces device performance and sensitivity for isolating cellular biomarkers. The low conductive DEP buffer was designed to maintain cell viability while allowing for DEP separation. In order to study cell viability, the effect of DEP buffer alone and under applied DEP was tested. A549 cells were placed in DEP buffer and cell viability was assessed over time using propidium iodide staining via flow cytometry. A549 cells had 98% viability after 30 minutes in DEP-buffer and 97% after 120 minutes (FIG. 19). To measure cell viability post DEP processing at 15 MHz/8 V, PBMCs were stained with calcein AM from the outlets and immediately measured via flow cytometry (FIG. 19). The side outlets had 99% viability while the center outlet had 97% viability, suggesting that enrichment via DEP is compatible with analytic techniques that require cell viability, morphology, and nucleic acid integrity to be maintained.

Label-Free Enrichment of KRAS Mutant Cells from PDAC Patients

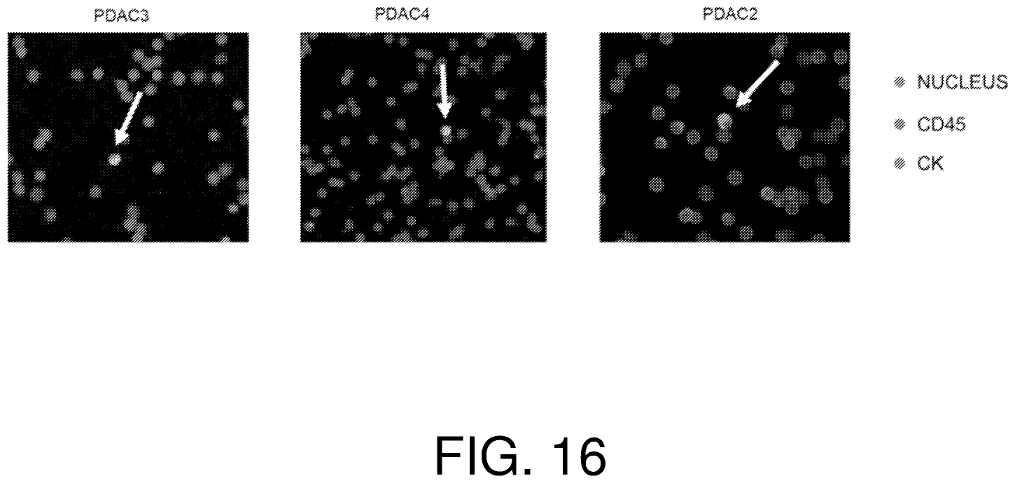

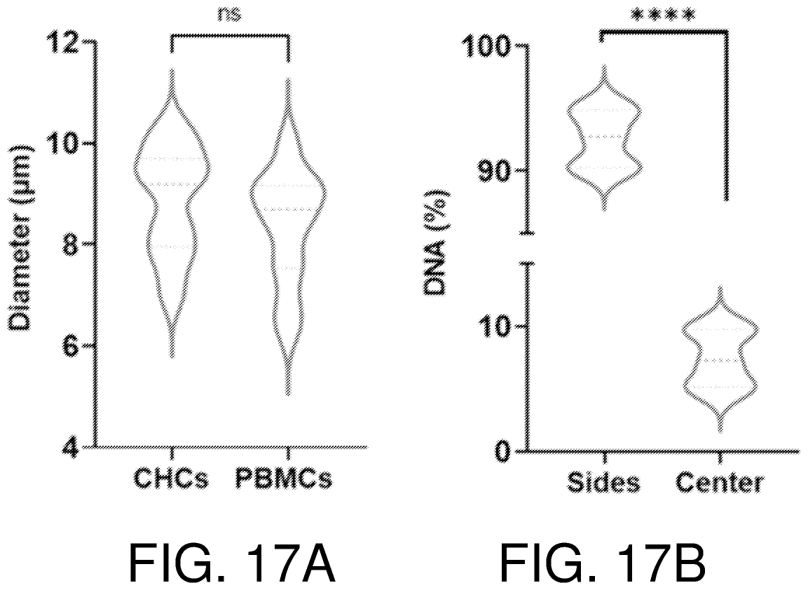

FIG. 16 illustrates in situ immunofluorescence microscopy analysis of PBMCs before device processing, arrows indicate presence of CHCs (Hoechst+/CD45+/CK+). FIG. 17A illustrates average diameter (μm) of CHCs and PBMCs from in situ immunofluorescence images. FIG. 17B illustrates average clinical sample DNA extracted from cells collected from all outlets (n=4).

To evaluate the ability of the microfluidic DEP sorting device to provide relevant clinical information when assessing peripheral blood from cancer patients, whether DEP-enriched CHCs could be used to evaluate KRAS mutational status was tested. Whole blood from four patients with PDAC (stage III-IV) was collected. All patients had clinically confirmed KRAS^{mut} primary tumors (Table 1). The majority of PDAC tumors harbor KRAS mutations and its presence in circulation, from circulating cells or cell free DNA, is clinically relevant for cancer detection (Waters et al., Cold Spring Harb Perspect Med, 8(9): a031435, September 2018, doi: 10.1101/cshperspect.a031435). Moreover, it was previously found that a subpopulation of FACS isolated CHCs have KRAS mutation as detected by ddPCR (Dietz et al., bioRxiv, 2021.03.11.434896, 2021, doi: 10.1101/2021.03.11.434896). To confirm the presence of CHCs in peripheral blood specimen prior to subjection to DEP, PBMCs were isolated from whole blood and analyzed as it had been previously reported (Gast et al., Sci Adv, 4(9): 7828-7840, 2018, doi: 10.1126/sciadv.aat7828; Dietz et al., bioRxiv, 2021.03.11.434896, 2021, doi: 10.1101/2021.03.11.434896). Briefly, PBMCs were adhered to glass slides then stained with antibodies against CD45 and CK, and visualized by fluorescence microscopy (FIG. 16). The size of CHCs (n=25) from all patients was 9.05±0.89 μm, and was comparable to the size of PBMCs (n=25) 8.57±0.89 μm, confirming the non-significant difference in size between these two populations (FIG. 17). As indicated, this negates the possibility of size-based isolation as a valid isolation method for CHCs further supporting the utility of label-free DEP enrichment (Gast et al., Sci Adv, 4(9): 7828-7840, 2018, doi: 10.1126/sciadv.aat7828). Peripheral blood specimen had non-detectable levels of CTCs (CD45−/CK+) by IHC, further supporting the promising nature of CHCs as an important cancer biomarker due to their detectability and potential for harboring clinically relevant information.

TABLE 1
Patient demographics

| | | | Primary | Intact | Stage at | | | 1° Tumor |
|---|---|---|---|---|---|---|---|---|
| Patient ID | Gender | Age | location | primary | collection | Metastasis | Treatment | KRAS^{mut} |
| PDAC3 | F | 75 | Pancreas | yes | IV | lung | yes | p.G12R |
| PDAC4 | F | 75 | Pancreas | yes | III | no | no | p.G12R |
| PDAC1 | F | 53 | Pancreas | yes | IV | liver | yes | p.G12D |
| PDAC2 | M | 76 | Pancreas | yes | III | no | no | p.G12D |

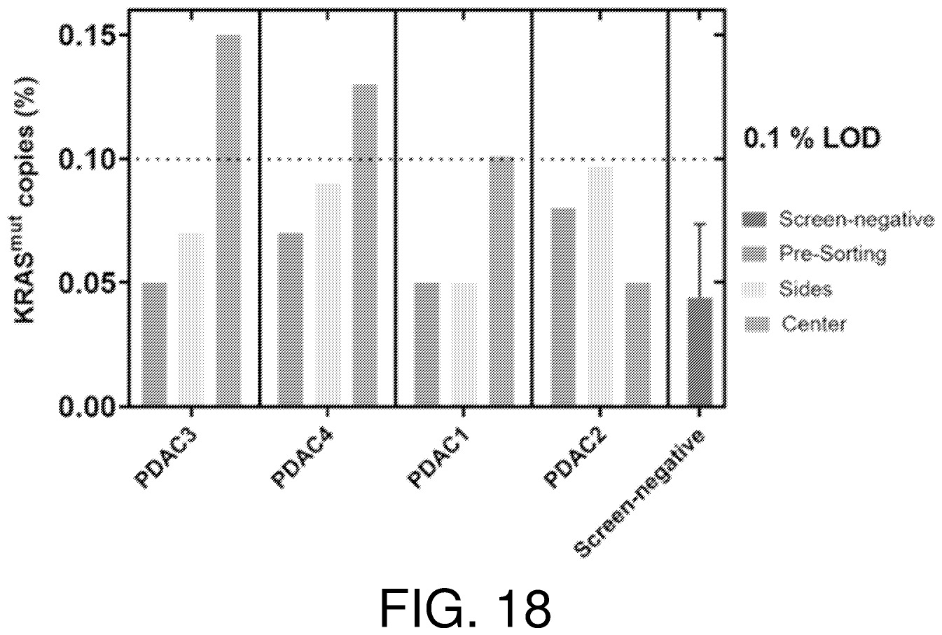

FIG. 18 illustrates percent KRAS^{mut} copies for each patient (n=4) from all outlets compared to average KRAS^{mut} copies for screen-negative controls (n=5) measured by ddPCR.

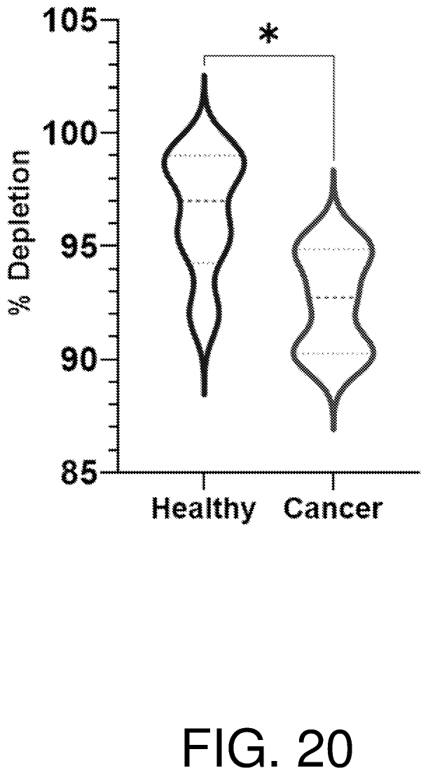

To demonstrate DEP-enriched CHCs harbored mutant KRAS, a smaller aliquot of patient PBMCs were subjected to DEP. A pre-sort aliquot was retained as a control (“Pre-sort”, FIG. 3D). Specimens were loaded onto the device (1×10⁶ cells) and all samples were processed for at least one hour at 15 MHz and 8 V, the optimal conditions for PBMC depletion. Cells were collected from side and center outlets and each channel was subjected to DNA extraction for downstream evaluation of KRAS mutations and total DNA was quantified using Qubit™ kits (FIG. 17B). Based on DNA concentration it was found that an average of 92.6%+2.07 (n=4) of the cells were depleted from the center which is comparable to previous results (FIG. 20) but significantly different than healthy controls (p=0.03, unpaired t test). PBMCs from diseased patients can be influenced by disease resulting in modified proportion of its subpopulation or like immunosenescence where senescent T-cells exhibit abnormal phenotypes (Ming et al., Front Oncol, 9:985, 2019, doi: 10.3389/fonc.2019.00985; Lian et al., J Hematol Oncol, 13:1:1-18, 2020, doi: 10.1186/s13045-020-00986-z). These complex factors may influence PBMC DEP response and lead to the utility of such biomarkers. In this way, optimizing the system to deplete healthy PBMCs in a label-free manner may reveal other disease related cells.

To demonstrate DEP-isolated CHCs harbor detectible KRAS mutations, isolated DNA was subjected to ddPCR. PBMCs of five screened negative subjects were used as controls. For all samples, ddPCR probes for the seven most common KRAS mutations in PDAC were evaluated. In three out of four patients analyzed, mutant KRAS alleles were identified in cells isolated from the center outlet while the side outlets only contained cells expressing wild-type KRAS (FIG. 18). For all other outlets and the screen-negative controls, the number of KRAS mutant copies detected were below the LOD for ddPCR (Morita et al., Nat Commun, 11(1): 1-17, 2020, doi: 10.1038/s41467-020-19119-8; Dong et al., Sci Rep, 8(1): 9650, 2018, doi: 10.1038/s41598-018-27368-3; Mission Bio. Performance of the Tapestri® Platform for Single-Cell Targeted DNA Sequencing [White paper]. Retrieved from missionbio.com/wp-content/uploads/2019/10/WhitePaper_MissionBio_TapestriPlatform_RevA.pdf; Azuara et al., Clin. Chem., 58(9): 1332-1341, 2012, doi: 10.1373/clinchem.2012.186577). PDAC3 had the highest number of KRAS mutant copies corresponding to 0.15% of the total DNA, followed by PDAC4 and PDAC1 with 0.13% and 0.1%, respectively. PDAC2 had non-detectable levels of KRAS mutations. Although the cohort is limited in number, KRAS mutations were identified in 75% of evaluated samples (p=0.048, Fisher Exact test), which is comparable to prior studies that only detected KRAS^{mut} CTCs in 72% of samples (Kulemann et al., Sci Rep, 7(1): 1-11, 2017, doi: 10.1038/s41598-017-04601-z).

The average KRAS mutant copies from the three KRAS positive samples was 0.13%. Typically KRAS positive cells are heterozygous therefore 0.26% of the cells were positive, corresponding to one KRAS mutant cell for every 385 wild-type cells post device processing (Almoguera et al., Cell, 53(4): 549-554, 1988, doi: 10.1016/0092-8674(88) 90571-5; Soh et al., PLOS One, 4:10, 2009, doi: 10.1371/journal.pone.0007464; Aguirre et al., Genes Dev., 17(24): 3112-3126, 2003, doi: 10.1101/gad.1158703). Previously Dietz at al. found an average of 30 CHCs (n=5) for every 500,000 PBMCs in PDAC patients and found that only 9.1% of CHCs were KRAS mutant, therefore the enrichment presented here could be as high as 476-fold. Considering that no CTCs were found by IHC, KRAS^{mut} cells may be CHCs or other important circulating tumor derived cells. The level of enrichment presented here is sufficiently above the LOD for current single cell technologies which could allow for a deeper understanding of circulating cancer cells and associated biology.

### Conclusion

In this Example 1, an approach addressing the challenge of targeting heterogeneous circulating biomarkers by focusing on healthy PBMCs with defined DEP response to reveal disease specific characteristics is presented. A DEP-driven microfluidic device fabricated with a V-shape electrode design is ideal for such a strategy. Thus, allowing for continuous mode processing of high cell density samples in a short amount of time. The utility of the workflow was optimized for depletion of PBMCs permitted maximal enrichment for a CHC model cell line. Using this approach, the device was used to process PBMCs from four PDAC patients and was coupled with genotypic downstream analysis using ddPCR. This workflow allowed for the identification of isolated cells with KRAS mutations above the limit of the detection in three out of four patients from only 2 mL of peripheral blood with one hour of sample processing. DEP-isolated CHCs harboring KRAS mutations was shown as a proof of concept, but the overall strategy may be applicable to other cancers or diseases with associated cellular biomarkers to provide clinically relevant readouts.

This technology may be coupled with droplet based single cell technologies, where both phenotypic and genotypic information can be studied simultaneously (Tapestri. (2020). Tapestri Single-cell Custom DNA and Protein Panels Uncover genotypic and phenotypic insights simultaneously from cells single cell[Brochure]. missionbio.com/wp-content/uploads/2020/12/Flyer_MissionBio_Custom_Panels_RevG.pdf; Qian et al., Cell Res., 30(9): 745-762, 2020, doi: 10.1038/s41422-020-0355-0). With further biological insights into these potential cellular biomarkers, clinical assays beyond KRAS mutation status may be developed. With the short sample processing time, low input volume, device reproducibility, and compatibility with downstream analytics, this method of cell enrichment by DEP shows promise as a clinical technology with the potential to improve current liquid biopsy strategies of cancer diagnosis and treatment monitoring.

### Materials and Methods

Fabrication and Operation of Microfluidic system

FIG. 19 illustrates cell viability over incubation time in various buffer conditions. DEP buffer shows high cells viability similar to standard cell culture media. FIG. 20 illustrates depletion of PBMCs from healthy participants based on Flow cytometry analysis and depletion of PDAC patients PBMCs based on DNA quantification.

The microfluidic DEP sorting device described here consists of two layers: a silicon chip with an interdigitated patterned electrode layer and a microfluidic PDMS chamber bonded through plasma treatment and heat curing. The bottom layer consists of three parts, a silicon substrate with 500 nm of wet-growth silicon dioxide (SiO₂) on both sides, and 90 nm thick of e-beam deposited platinum electrodes as the conductive components for DEP actuation, and silicon dioxide passivated the edge of the electrodes. The electrodes were interdigitated-separated into two batches to form multiple independent electrodes pairs to actuate the sample in the device. The edge of the electrode is designed to be 15 μm from the wall of flow channel, the silicon dioxide passivation avoided cells being trapped at the region where DEP forces is much stronger than the flow stress. The passivation ensures enough shear force to carry sorted cells along the direction of flow.

The device has two DEP actuation region that are connected to two independent pairs of electrode pads. Each electrode pads has two identical circular areas, one was wired bonded by fast drying silver paint (Ted Pella Inc.) and connected to power amplifier (Model 9260, Tabor Electronics Inc.) in series with a waveform generator (33622A, Keysight), the other electrode pad was used to monitor voltage and frequency on the device by connected with an oscilloscope (DSOX2024A, Keysight) at the beginning of each experiment and every time parameters were adjusted. The wired device was place on a water-cooled aluminum heat sink to keep device at or below room temperature. The complete setup was placed under a microscope for real time monitoring.

The microfluidic chamber (FIG. 19) includes one sample inlet of 0.5 mm width and two sheath flow inlets of 1 mm for a total ratio of 4:1 sheath to sample ratio. The total chamber width is 2 mm which allowed viewing the entire channel within a field of view by a 5× fluorescence microscope objective as shown in FIG. 13. At the outlet, to allow only highly responsive cells to be depleted from the sample, the center outlet was designed to be wider than the top and bottom outlet. The center outlet is 0.9 mm, and the sides are 0.8 mm each for a total ratio of 16:9 sheath to sample. The flow is pulled from all three outlets by two flow-driven syringe pumps, the withdrawal setup provides enhanced flow stability compared to active infusion from the inlets. The center-focused flow was adjusted to a flow rate of 2 μL/minute for each of the sheath flow and 2.5 μL/minute for the center outlet.

### Microfluidic System Preparation and Assembly

Polydimethylsiloxane (PDMS, Sylgard 184, Dow Corning, MI) was prepared as the standard 10:1 ratio and cured at 65° C. for at least 2 h and cooled down at room temperature before use. Then, inlets were punctured with 2 mm biopsy puncture (Ted Pella, Inc.) and outlets were puncture with 1 mm biopsy puncture (Ted Pella, Inc.). The PDMS part was cleaned by sonication in isopropanol, then PDMS chamber was gas dried followed by incubation in the 80° C. oven for at least 15 minutes prior to assembly. On the other hand, the electrode patterned silica wafer was sequentially cleaned by acetone, methanol, isopropanol and deionized water. The device was dried by pressurized nitrogen gas prior to assembly.

Both the PDMS microfluidic chamber and silicon chip were treated with oxygen plasma (35 W, 600 mtorr) for 1 minute. The PDMS chamber was aligned to the fiducial on the silicon chip under a stereoscope and placed on a hot plate at 95° C. for 60 minutes followed by air cool until room temperature. After PDMS-silicon chip bonding process, 21-gauge wire was wired to the electrode pad using fast drying silver paint (Ted Pella, Inc.) and left at room temperature for 1 hour before incubated at 80° C. for 1 hour to fully dry the silver paint. The 5 minutes epoxy was applied on the electrode pad and silver paint to enhance mechanical strength of the wiring. The device was incubated at 80° C. for more 30 minutes and cooled down to room temperature prior to the experiment.

For each experiment, 20 cm PTFE tubing (24 AWG, Allied Electronics) was connected to a 1 mL syringe. In addition, 0.5 cm Tygon® tubing (OD: 2.286 mm, ID: 1.270 mm) was plugged into the inlets of the device, and a 1 mL pipette was cut approximately in half and inserted on the inlet tubing of the side channels to create a reservoir of sheath flow. A 200 μl pipette was inserted on the tubing on the center to create a sample reservoir. Finally, the device was placed on a recirculating water-cooled aluminum fixture, and monitored by a microscope.

### DEP Buffer

To make DEP buffer, 90000 mg of sucrose (Thermo Fisher Scientific), 12086 mg of dextrose (Thermo Fisher Scientific), and 2000 mg of bovine serum albumin (BSA) was dissolved in deionized water (18.2 MOhm-cm) with the total volume of 900 mL. 95 mL of Dulbecco's modified Eagle's Media (DMEM) supplemented with 10% fetal bovine serum (FBS) was then added to make a final volume of 950 mL solution. The conductivity of the buffer was adjusted to 145 mS/m by adding DMEM with 10% FBS supplement. The final solution was filtrated by 0.22 μm filter and preserved in 4° C.

### Bead Sorting

Prior to each experiment DEP buffer was placed under vacuum for at least 30 minutes to degas it. 10 μm FluoSpheres™ Polystyrene Microspheres and 2.0 μm FluoSpheres™ Carboxylate-Modified Microspheres were diluted to a total of 1×10⁶ beads. The bead mixture was then centrifuged and suspended on 100 μl of degassed cold DEP buffer. This solution was then introduced on the microfluidic device and different conditions as described on FIG. 1C were applied. For each condition, the solution was processed for at least 30 minutes, outlets collected, measured using BD FACS Symphony and analyzed with FlowJo.

### Cell Culture

MCF7 (breast adenocarcinoma) were purchased from American Type Culture Collection (ATCC, Manassas, VA) and maintained in Dulbecco's modified Eagle's Media (DMEM) supplemented with 10% fetal bovine serum (FBS) and 1% Penicillin Streptomycin Glutamine (PSG). B16F10-macrophage hybrids (B16Mφ) were previously generated and maintained in Dulbecco's modified Eagle's Media (DMEM) supplemented with 10% fetal bovine serum (FBS) and 1% Penicillin Streptomycin Glutamine (PSG) (Gast et al., Sci Adv, 4(9): 7828-7840, 2018, doi: 10.1126/sciadv.aat7828).

### Cell Line PBMC DEP Analysis

Prior to each experiment DEP buffer was placed under vacuum for at least 30 minutes to degas it. Deidentified healthy participant whole blood was obtained from the CEDAR repository following IRB protocol into either a Heparin (BD367874) or ACD (BD364606) vacutainer tubes. Within 15 minutes of the blood draw, 8-10 mL of whole blood was processed following the SepMate™ (STEMCELL Technologies, cat #85450) protocol. Cells were counted using the Countess™ II (Applied Biosystems) automated cell counter and diluted to 1×10⁷ cells/mL in cold PBS and stored on ice. Cell lines were trypsinized, washed, and reconstituted in DEP buffer. Prior to loading into the DEP device, 100 μl of cell solution was diluted to 1 mL in DEP buffer, centrifuged for 5 minutes at 300 g, and reconstituted in 60-80 μl DEP buffer. Reconstituted cells were loaded into the center channel inlet and collected for at least 30 minutes at each specific frequency and voltage combination. In the case of the spiking experiments, 50,000 B16Mφ cells were added for per 1×10⁶ PBMCs prior to loading into the device. Each outlet was collected, transferred to standard 5 ml round bottom polystyrene flow cytometry tubes, stained with AF647-CD45 (BioLegend, clone H130), PE-CD3 (BioLegend, clone HIT3a), AF488-CD19 (eBioscience, clone HIB19) and V450-CD14 (BD Horizon, clone MqP9) on ice for at least 30 minutes, measured on BD flow cytometry Symphony, and analyzed with FlowJo.

### Viability Testing

To measure the viability of cells in DEP buffer alone, A549 cells were placed in either DMEM or DEP buffer on ice and serially sampled every 30 minutes. Each sample was stained with propidium iodide (PI), measured on BD flow cytometry Symphony, and analyzed with FlowJo. PI+ cells were considered dead or dying. To measure the viability of cells post-DEP sorting through the device, cells were collected at each outlet and stained with Calcien AM (Invitrogen™ C3099). As before, cells were flow cytometry analyzed and Calcein AM positive cells were considered viable.

### Clinical Sample Processing for Immunofluorescence

Separation of PBMCs using Ficoll-Paque was as described in (Malech et al., Neutrophil Methods and Protocols. Humana Totowa NJ. doi.org/10.1007/978-1-59745-467-4, 2007) with some modification. 5-10 mL of whole blood was 1:1 diluted to DPBS with 2% FBS at room temperature. Diluted blood sample was layered on top of 20 mL of Ficoll-Paque PLUS (GE Healthcare), and centrifuged at 800 rcf for 20 mins. PBMCs layer was carefully extracted and resuspended in DPBS with 2% FBS. To perform with concentrated cells, the resuspended sample was centrifuged at 400 rcf for 5 mins followed by resuspension with an intended volume of DPBS with 2% FBS.

For evaluation of CHCs, samples were first treated with a 5% bovine serum albumin solution, followed by TrueBlack Lipofuscin Autofluorescence Quencher (Biotium), and Image-IT FX Signal Enhancer (Invitrogen), then stained with fluorescent-conjugated antibodies for pan-cytokeratin (CK; eBioscience, clone: AE1/AE), and CD45 (Biolegend, clone: HI30), and counterstained with the nuclear dye, DAPI. Each sample was processed with unstained and isotype controls (eBioscience). Specimens were digitally imaged with a Zeiss AxioScanner. PBMC and CHC size was measured using the Zen software ruler.

### Clinical Sample Processing for DEP Device

Deidentified samples were retrieved from Oregon Health & Science University (OHSU) under the Oregon Pancreas Tissue Registry and the Brenden-Colson Center for Pancreatic Care. Informed consent was obtained from all subjects. All experimental protocols were approved by the OHSU Institutional Review Board. All methods were carried out in accordance with relevant guidelines and regulations. At least 1.5 mL of whole blood was processed immediately using SepMate™ (STEMCELL Technologies, cat #85450) protocol. Cells were counted using Countess™ II (Applied Biosystems) automated cell counter and diluted to 1×10⁷ cells/mL in cold DEP buffer and stored on ice. As previously described, the chip was primed with degassed DEP buffer and the voltage/frequency parameters were set prior to sample loading. The total sample (60-100 μL) was loaded onto the chip and processed for at least 30 minutes but not more than 60 minutes.

### DNA Extraction and Droplet Digital PCR

After all outlets were collected, samples were centrifuged at 800 g for 5 minutes and supernatant was removed. Then Pure™ DNA Extraction Kit was used according to the manufacturer's protocol. Briefly, 155 μL of digestion buffer was added to the lyophilized proteinase K and resuspended by pipetting up and down for at least 20 times. 150 μL of that solution was added to the cell pellets of every outlet and incubated at 65° C. for at least 3 hours. After incubation, Ampure XP beads with a 1.2× ratio (v/v) was added and DNA was isolated according to the manufacturer's protocol. Briefly, samples were under rotation for 10 minutes prior to magnetic separation of beads and discarding of the supernatant. Then 80% ethanol was added to the tube, with samples still in the magnetic rag, and incubated for 30 seconds before discarding the supernatant. This process was repeated twice and then 11 microliters of water were added to the beads and resuspended. Samples were incubated for 10 minutes prior to collection of 10 microliters of DNA, which were either used immediately or stored at −20° C. ddPCR was performed using the ddPCR™ KRAS G12/G13 Screening Kit #1863506 (Bio-Rad Laboratories, CA). Droplets were generated with the Auto Droplet Generator (Bio-Rad Laboratories, CA) and measured on the QX200™ Droplet Reader (Bio-Rad Laboratories, CA). PCR parameters were set according to manufacturer's recommendations, 95° C. for 10 minutes, followed by 40 cycles of 94° C. for 30 s and 55° C. for 1 minute, followed by 10 minutes of 98° C. Mutant and wild type KRAS thresholds were set to ≥99% of mutant (A549 cell line) and wild type (A375 cell line) controls were positive and 100% of blanks were negative.

Further, the processes discussed herein may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skills in the art will readily recognize that certain steps or operations illustrated in the figures above may be eliminated, combined, or performed in an alternate order. Any steps or operations may be performed serially or in parallel (unless the context requires one or the other). Furthermore, the order in which the operations are described is not intended to be construed as a limitation.

Embodiments may be provided as a software program or computer program product including a non-transitory computer-readable storage medium having stored thereon instructions (in compressed or uncompressed form) that may be used to program a computer (or other electronic device) to perform processes or methods described herein. The computer-readable storage medium may be one or more of an electronic storage medium, a magnetic storage medium, an optical storage medium, a quantum storage medium, and so forth. For example, the computer-readable storage media may include, but is not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions. Further, embodiments may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program can be configured to access, including signals transferred by one or more networks. For example, the transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case, and a variety of alternative implementations will be understood by those having ordinary skills in the art.

Additionally, those having ordinary skills in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

Those of ordinary skill in the art will recognize in light of the present disclosure that many changes can be made to the specific embodiments disclosed herein and still obtain a like or similar result without departing from the spirit and scope of the disclosure.

What is claimed is:

1. A system for sorting particles in fluids, comprising:
a microfluidic chamber configured to allow fluid to flow therethrough, the microfluidic chamber including a substrate;
at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and
a controller configured to control the at least one array of electrodes;
wherein the substrate and the at least one array of electrodes constitute a chip, and no overall coating is provided on the chip.

2. A system for sorting particles in fluids, comprising:
a microfluidic chamber configured to allow fluid to flow therethrough, the microfluidic chamber including a substrate;
at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and
a controller configured to control the at least one array of electrodes;
wherein a total length of the at least one array of electrodes is between 65% and 95% of a length of the microfluidic chamber.

3. A system for sorting particles in fluids, comprising:
a microfluidic chamber configured to allow fluid to flow therethrough, the microfluidic chamber including a substrate;
at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and
a controller configured to control the at least one array of electrodes;
wherein an edge portion of the respective electrode is covered with insulating material, and a width of the edge portion of the respective electrode covered with the insulating material is between 5% and 15% of a width of the microfluidic chamber.

4. A system for sorting particles in fluids, comprising:
a microfluidic chamber configured to allow fluid to flow therethrough, the microfluidic chamber including a substrate;
at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and
a controller configured to control the at least one array of electrodes;
wherein a total length of the at least one array of electrodes is between 65% and 95% of a length of the microfluidic chamber.

5. A system for sorting particles in fluids, comprising:
a microfluidic chamber configured to allow fluid to flow therethrough, the microfluidic chamber including a substrate;
at least one array of electrodes arranged on the substrate, the at least one array of electrodes being configured to apply dielectrophoretic (DEP) forces to the fluid flowing through the microfluidic chamber, wherein a respective electrode of the at least one array of electrodes is configured to have a V-shape; and
a controller configured to control the at least one array of electrodes.

6. The system of claim 5, wherein the microfluidic chamber further comprises:
a first inlet configured to introduce a sample into the microfluidic chamber; and
a plurality of outlets configured to collect a plurality of types of particles in the sample.

7. The system of claim 5, further comprising a buffer exchange module configured to mix a buffer and the sample, the buffer exchange module being in fluid communication with the first inlet.

8. The system of claim 5, wherein the sample includes cells, synthetic micro-particles, nano-particles, viruses, bacteria, nucleic acids, and/or proteins.

9. The system of claim 5, wherein the sample includes prokaryotic cells and/or eukaryotic cells.

10. The system of claim 5, wherein the sample includes red blood cells (RBCs), lymphocytes, circulating hybrid cells (CHCs), fusion cells, and/or disease related cells.

11. The system of claim 5, wherein a ratio of a distance to a width of the microfluidic chamber is between 1:10 and 2:1, the distance being measured from the first inlet to an apex of a first array of electrodes of the at least one array of electrodes.

12. The system of claim 5, wherein the microfluidic chamber further comprises a second inlet and a third inlet configured to introduce sheath flows into the microfluidic chamber.

13. The system of claim 12, wherein a ratio of a first width of the first inlet to a second width of the second inlet to a third width of the third inlet is between 0.5:1:1 and 2:1:1.

14. The system of claim 13, wherein the ratio of the first width of the first inlet to the second width of the second inlet to the third width of the third inlet is 1:1.5:1.5.

15. The system of claim 5, wherein the plurality of outlets include a first outlet, a second outlet, and a third outlet; and wherein a ratio of a fourth width of the first outlet to a fifth width of the second outlet to a sixth width of the third outlet is between 0.2:1:1 and 8:1:1.

16. The system of claim 15, wherein the ratio of the fourth width of the first outlet to the fifth width of the second outlet to the sixth width of the third outlet is 1.73:1:1.

17. The system of claim 5, wherein the buffer has a relatively low conductivity between 20 mS/m and 800 mS/m.

18. The system of claim 5, wherein the buffer includes at least one of dextrose, sucrose, water, bovine serum albumin, fetal bovine serum, sugars, proteins, amino acids, salts, and/or lipids.

19. The system of any one of claims 1-5, wherein a length of the microfluidic chamber is between 10 mm and 50 mm.

20. The system of any one of claims 1-5, wherein a width of the microfluidic chamber is between 0.5 mm and 5 mm.

21. The system of any one of claims 1-5, wherein a height of the microfluidic chamber is between 20 μm and 100 μm.

22. The system of any one of claims 1-5, wherein a first array of electrodes of the at least one array of electrodes is configured to operate at a frequency between 1 Mhz and 20 Mhz and a voltage between 5 Volt (V) and 20 V.

23. The system of any one of claims 1-5, wherein a second array of electrodes of the at least one array of electrodes is configured to operate at a frequency between 4 Mhz and 9 Mhz and a voltage between 5 V and 20 V.

24. The system of any one of claims 1-5, wherein a third array of electrodes of the at least one array of electrodes is configured to operate at a frequency between 9 Mhz and 14 Mhz and a voltage between 5 V and 20 V.

25. The system of any one of claims 1-5, wherein a respective array of electrodes of the at least one array of electrodes includes 60 pairs of interdigitated electrodes.

26. The system of any one of claims 1-5, wherein a total length of the at least one array of electrodes is between 65% and 95% of a length of the microfluidic chamber.

27. The system of any one of claims 1-5, wherein a length of a respective array of electrodes of the at least one array of electrodes is between 5 mm and 50 mm.

28. The system of any one of claims 1-5, wherein a first gap is arranged between a first array of electrodes and a second array of electrodes of the at least one array of electrodes, and a first width of the first gap is between 250 μm to 1 mm.

29. The system of claim 28, wherein a second gap is arranged between a second array of electrodes and a third array of electrodes of the at least one array of electrodes, and a second width of the second gap is between 250 μm to 1 mm.

30. The system of any one of claims 1-5, wherein a width of the respective electrode is between 10 μm and 50 μm.

31. The system of any one of claims 1-5, wherein a spacing is arranged between two adjacent electrodes of a respective array of electrodes of the at least one array of electrodes, and a ratio of a width of the respective electrode to a width of the spacing is between 1:0.5 and 1:1.5.

32. The system of any one of claims 1-5, wherein an edge portion of the respective electrode is covered with insulating material.

33. The system of claim 32, wherein a width of the edge portion of the respective electrode covered with the insulating material is between 5% and 15% of a width of the microfluidic chamber.

34. The system of any one of claims 1-5, wherein a distance between an endpoint of the respective electrode and a sidewall of the microfluidic chamber is between 50 μm and 300 μm.

35. The system of any one of claims 1-5, wherein the respective electrode includes a first segment and a second segment connected to the first segment at an apex, the first segment and the second segment forming the V-shape, an angle between the first segment and the second segment being between 30 degrees and 60 degrees.

36. The system of any one of claims 1-5, wherein the substrate and the at least one array of electrodes constitute a chip, and no overall coating is provided on the chip.

37. A method for sorting particles in fluids using the system for sorting particles in fluids of any of claims 1-5, comprising:
introducing a fluid sample into the microfluidic chamber via a first inlet of the microfluidic chamber;
controlling at least one array of electrodes to apply dielectrophoretic (DEP) forces to the fluid sample flowing through the microfluidic chamber; and
collecting a plurality of types of particles in the fluid sample at a plurality of outlets of the microfluidic chamber.

38. A method for sorting particles in fluids, comprising:
introducing a fluid sample into a microfluidic chamber via a first inlet of the microfluidic chamber of a microfluidic system, the microfluidic chamber being configured to allow the fluid sample to flow therethrough;
controlling at least one array of electrodes to apply dielectrophoretic (DEP) forces to the fluid sample flowing through the microfluidic chamber, wherein the at least one array of electrodes are arranged on a substrate in the microfluidic chamber, and a respective electrode of the plurality of the arrays of electrodes is configured to have a V-shape; and
collecting a plurality of types of particles in the fluid sample at a plurality of outlets of the microfluidic chamber.

39. The method of claim 38, wherein controlling the at least one array of electrodes comprises:
controlling a first array of electrodes of the at least one array of electrodes to operate based on a first set of parameters; and
controlling a second array of electrodes of the at least one array of electrodes to operate based on a second set of parameters.

40. The method of claim 39, wherein the first set of parameters includes a first frequency between 1 Mhz and 20 Mhz and a first voltage between 5 V and 20 V.

41. The method of claim 39, wherein the second set of parameters includes a second frequency between 4 Mhz and 9 Mhz and a second voltage between 5 V and 20 V.

42. The method of claim 38, wherein controlling the at least one array of electrodes further comprises:
controlling a third array of electrodes of the at least one array of electrodes to operate based on a third set of parameters.

43. The method of claim 42, wherein the third set of parameters includes a third frequency between 9 Mhz and 14 Mhz and a third voltage between 5 V and 20 V.

44. The method of claim 38, further comprising:
introducing sheath flows into the microfluidic chamber via a second inlet and a third inlet of the microfluidic chamber.

45. The method of claim 42, wherein the fluid sample includes cells, synthetic micro-particles, nano-particles, viruses, bacteria, nucleic acids, and/or proteins.

46. The method of claim 42, wherein the fluid sample includes prokaryotic cells and/or eukaryotic cells.

47. The method of claim 42, wherein the fluid sample includes a first type of particle, a second type of particle, and/or a third type of particle.

48. The method of claim 47, wherein the first type of particle includes red blood cells (RBCs), the second type of particle includes lymphocytes, and the third type of particle includes circulating hybrid cells (CHCs).

49. A computer-readable storage medium storing computer-readable instructions executable by one or more processors, that when executed by the one or more processors, cause the one or more processors to perform operations comprising:
introducing a fluid sample into a microfluidic chamber of the system for sorting particles in fluids of any of claims 1-5 via a first inlet of the microfluidic chamber;
controlling at least one array of electrodes to apply dielectrophoretic (DEP) forces to the fluid sample flowing through the microfluidic chamber; and
collecting a plurality of types of particles in the fluid sample at a plurality of outlets of the microfluidic chamber.

50. A computer-readable storage medium storing computer-readable instructions executable by one or more processors, that when executed by the one or more processors, cause the one or more processors to perform operations comprising:
introducing a fluid sample into a microfluidic chamber via a first inlet of the microfluidic chamber, the microfluidic chamber being configured to allow the fluid sample to flow therethrough;
controlling at least one array of electrodes to apply dielectrophoretic (DEP) forces to the fluid sample flowing through the microfluidic chamber, wherein the at least one array of electrodes are arranged on a substrate in the microfluidic chamber, and a respective electrode of the at least one array of electrodes is configured to have a V-shape; and
collecting a plurality of types of particles in the fluid sample at a plurality of outlets of the microfluidic chamber.

51. The computer-readable storage medium of claim 50, wherein controlling the at least one array of electrodes comprises:
controlling a first array of electrodes of the at least one array of electrodes to operate at a first set of parameters; and
controlling a second array of electrodes of the at least one array of electrodes to operate at a second set of parameters.

52. The computer-readable storage medium of claim 51, wherein the first set of parameters includes a first frequency between 1 Mhz and 20 Mhz and a first voltage between 5 V and 20 V.

53. The computer-readable storage medium of claim 51, the second set of parameters includes a second frequency between 4 Mhz and 9 Mhz and a second voltage between 5 V and 20 V.

54. The computer-readable storage medium of claim 50, wherein controlling the at least one array of electrodes further comprises:
controlling a third array of electrodes of the at least one array of electrodes to operate at a third set of parameters.

55. The computer-readable storage medium of claim 54, wherein the third set of parameters includes a third frequency between 9 Mhz and 14 Mhz and a third voltage between 5 V and 20 V.
